(19) United States
(12) Patent Application Publication
(10) Pub. No.: US 2026/0289647 A1
(43) Pub. Date: Sep. 24, 2026

(54) SYSTEM

(71) Applicant: SoftBank Group Corp., Tokyo (JP)

(72) Inventor: Shota MORI, Tokyo (JP)

(73) Assignee: SoftBank Group Corp., Tokyo (JP)

(21) Appl. No.: 19/561,697

(22) Filed: Mar. 10, 2026

(30) Foreign Application Priority Data
Mar. 19, 2025 (JP) 2025-044536

(51) Int. Cl. G06Q 30/0601; G06N 3/045; G06N 3/0475

(52) U.S. Cl. CPC G06Q 30/06311; G06N 3/045; G06N 3/0475

(57) ABSTRACT

A system includes a processor that is configured to collect input data of a user, generate a prompt sentence by using a generative AI model, and generate a clothing recommendation based on the generated prompt sentence.

### CROSS-REFERENCE TO RELATED APPLICATION

This application is based on and claims priority under 35 USC 119 from Japanese Patent Application No. 2025-044536 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recommendation systems for clothing and meal planning generally rely on fixed rules or manually designed recommendation logic, and therefore are limited in their ability to flexibly respond to diverse user inputs such as budget, fashion preference, current body type, and ideal body type. As a result, such systems often fail to provide recommendations that are sufficiently personalized, coherent in style and diet strategy, and consistent with the user's overall goals for appearance and body shape. In particular, known systems are not configured to dynamically generate natural language prompts tailored to the user's specific situation, and then leverage a generative AI model to produce integrated recommendations for both clothing proposals and meal plans. This can lead to suboptimal user experiences, where fashion suggestions and diet plans are fragmented, difficult to adapt, and not well aligned with each other or with the user's explicitly stated preferences and targets. Therefore, there is a need for a system that is capable of collecting user input data, automatically generating appropriate prompt sentences for a generative AI model, and producing personalized clothing recommendations and meal plans in a coherent and efficient manner.

### SUMMARY

In order to solve the above-described problems, an embodiment of the present invention provides a system comprising a processor, wherein the processor is configured to collect input data of a user, generate a prompt sentence by using a generative AI model, and generate a clothing recommendation based on the generated prompt sentence. In one aspect, the processor is configured to generate, for automatic proposal of clothing based on a budget and a preference of the user, the prompt sentence to be input to the generative AI model, thereby enabling the generative AI model to output clothing suggestions that are constrained by the user's budget and aligned with the user's preferred fashion style. In another aspect, the processor is configured to input the prompt sentence to the generative AI model and generate a meal plan in order to provide an optimal meal plan based on a current body type and an ideal body type of the user, thereby allowing the system to output diet plans tailored to the user's specific body-shape goals. By integrating these functions, the system is able to automatically construct context-rich prompt sentences from various kinds of user input, utilize the generative AI model to produce personalized clothing and meal recommendations, and present coherent and highly adaptable proposals that address both fashion selection and body-shape management in a unified manner.

The term “system” refers to an apparatus or a combination of hardware and software components that collectively execute one or more processing functions, and that includes at least one processor configured to perform operations as described in the claims.

The term “processor” refers to any hardware processing unit or combination of units, such as a central processing unit (CPU), graphics processing unit (GPU), dedicated AI accelerator, microcontroller, or a plurality thereof, that executes instructions to perform the functions and operations recited in the claims.

The term “user” refers to a human individual who provides input data to the system, such as budget information, fashion preferences, current body type, and ideal body type, and who receives clothing recommendations and meal plans generated by the system.

The term “input data” refers to any information provided by the user to the system, including but not limited to budget values, fashion preferences, current body type information, and ideal body type information, which is used by the processor to generate prompt sentences and recommendations.

The term “prompt sentence” refers to a natural language or structured text sequence that is generated or prepared by the processor and is suitable for input to a generative AI model in order to cause the generative AI model to output a clothing recommendation or a meal plan.

The term “generative AI model” refers to an artificial intelligence model, such as a large language model or other machine-learning-based generative model, that is configured to receive a prompt sentence as input and to generate, based on the prompt sentence, output text including at least part of a clothing recommendation or a meal plan.

The term “clothing recommendation” refers to information generated by the system that proposes one or more clothing items, outfits, or styles to the user, the information being based at least in part on the generated prompt sentence and on the user's budget and/or preferences.

The term “budget” refers to a numerical value or range representing an amount of money specified by the user, which is used by the processor as a constraint or condition when generating the prompt sentence and the resulting clothing recommendation.

The term “preference” refers to information representing the user's desired clothing style, category, or taste, such as casual or business casual, which is used by the processor to tailor the prompt sentence and the clothing recommendation to the user's fashion interests.

The term “meal plan” refers to a structured set of dietary suggestions, including at least recommended foods, meals, or nutritional guidelines, that is generated by the system based on the output of the generative AI model and is tailored to the user's current body type and ideal body type.

The term “current body type” refers to information representing a present physical condition of the user's body, such as body weight, body shape characteristics, or proportions, which is used by the processor as input data for generating a prompt sentence and a corresponding meal plan.

The term “ideal body type” refers to information representing a target or desired physical condition of the user's body, such as target weight, target body shape, or proportions, which is used by the processor together with the current body type to generate a prompt sentence and to obtain a meal plan aimed at achieving the desired condition.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

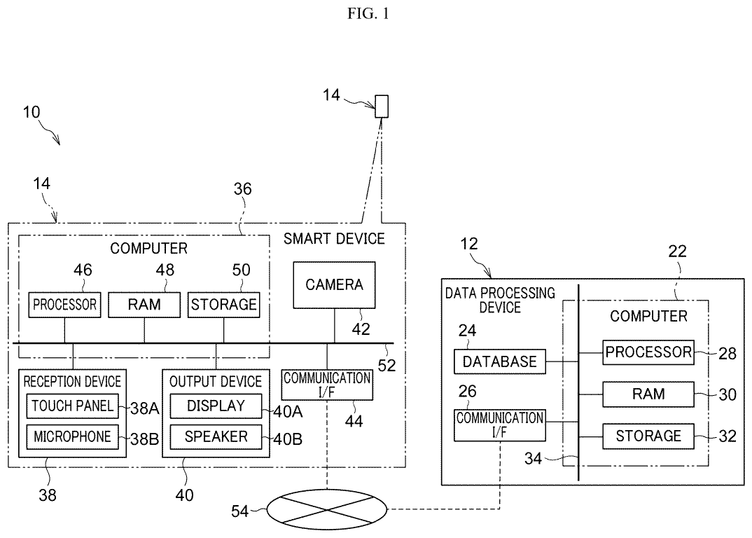

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

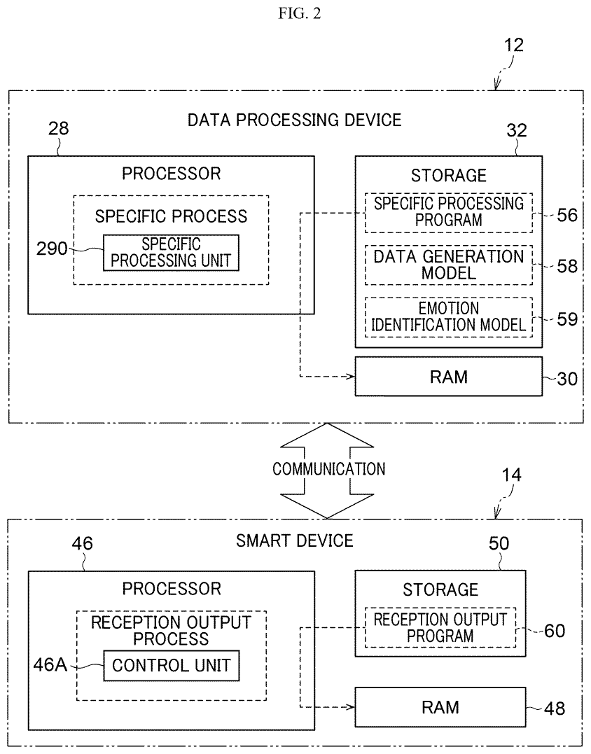

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional recommendation systems for consumer products and lifestyle guidance typically separate product selection logic from health or diet planning logic, and treat both as static rule-based processes. In such systems, a server often applies fixed filtering rules to tabular data and returns a simple list of items to a terminal. When a user wishes to select clothing within a particular budget and style preference while also obtaining a meal plan tailored to a current body condition and a target body condition, the server must either execute multiple disjoint workflows or rely heavily on manual configuration. As a result, the system consumes excessive computing resources to orchestrate multiple subsystems, repeats similar data processing steps, and cannot flexibly adapt its behavior when the input conditions or available items change.

Furthermore, in many existing architectures, a generative AI model is used only as a generic text generator, without a well-defined mechanism in the server to construct structured, context-rich prompt sentences that encode both database retrieval results and user-specific constraints in a unified manner. This leads to suboptimal utilization of generative AI capabilities, increased latency due to repeated trial-and-error prompting from the client side, and inconsistent response formats that complicate subsequent data processing. From a computer technology perspective, the lack of a systematic server-side pipeline for: (i) normalizing heterogeneous user inputs, (ii) integrating structured item data and nutrition data, (iii) generating multiple, purpose-specific prompt sentences, and (iv) aggregating multi-model outputs into a coherent response, results in inefficient use of processor time, memory, and network bandwidth.

In addition, conventional systems often require the terminal to perform substantial logic for formatting prompts or reconciling outputs, which increases processing load and implementation complexity on resource-constrained devices. This architecture complicates error handling and makes it difficult to guarantee consistent quality of recommendations across different terminals and network environments. There is therefore a need for an improved computer-implemented technique in which a server-side processor centrally manages acquisition and structuring of user input, retrieval and integration of item and nutrition information, generation of optimized prompt sentences for different generative AI models, and synthesis of outputs into response information that can be efficiently rendered on a terminal. Such a technique should enhance the efficiency, scalability, and reliability of the overall system by improving how the processor cooperates with storage devices and generative AI models.

The specific processing by the specific processing unit 290 of the data processing device 12 in Example 1 is realized by the following means.

The present invention provides a server comprising a processor and a storage device, the processor being configured to acquire, from a terminal operated by a user, input information including budget information, preference information, current body information, and target body information, to convert the input information into structured information and store the structured information in the storage device, to retrieve, based on the structured information, merchandise information that satisfies a price condition and a preference condition and nutrition information related to the current body information and the target body information from an information storage region, to generate document information by integrating the structured information and retrieval results, to generate, based on the document information, a first prompt sentence for input to a clothing-proposal generative AI model and a second prompt sentence for input to a meal-plan generative AI model, to input the first prompt sentence to the clothing-proposal generative AI model to obtain clothing proposal information and to input the second prompt sentence to the meal-plan generative AI model to obtain meal plan information, to generate response information by integrating the clothing proposal information and the meal plan information, and to transmit the response information to the terminal for display. This enables the server to implement an efficient and unified data-processing pipeline in which heterogeneous user input is normalized once, combined with structured merchandise and nutrition data, and converted into optimized, purpose-specific prompt sentences for multiple generative AI models, thereby improving utilization of computational resources, reducing redundant processing on the terminal, and providing consistent, high-quality recommendations and meal plans with reduced latency and improved scalability of the overall computer system.

The term “processor” refers to a hardware or software execution unit, such as a central processing unit, a microprocessor, a graphics processing unit, or a combination thereof, that executes instructions to perform data processing operations described in the present specification.

The term “terminal” refers to an information processing apparatus operated by a user, such as a mobile device, a tablet device, a desktop device, or a web client, that is configured to transmit input information to a server and to receive and display response information.

The term “input information” refers to information provided by a user through the terminal, including at least budget information, preference information, current body information, and target body information.

The term “budget information” refers to information indicating a monetary constraint or allowable expenditure amount specified by a user for acquisition of merchandise.

The term “preference information” refers to information indicating a user's desired characteristics or tendencies, such as style, category, or design preference, to be considered when selecting merchandise.

The term “current body information” refers to information representing a user's present physical condition, such as body size, body shape, body weight, or other body-related parameters.

The term “target body information” refers to information representing a desired physical condition of the user, such as a target body size, target body shape, target body weight, or other body-related parameters that the user intends to achieve.

The term “structured information” refers to input information that has been converted into a predetermined data structure, such as a record, an object, or a table, in which individual elements of the input information are stored in association with corresponding fields or attributes.

The term “storage device” refers to a physical or virtual storage resource, such as a memory device, a magnetic storage device, a solid-state storage device, or a networked storage system, configured to store structured information, merchandise information, nutrition information, or other data.

The term “information storage region” refers to a logical or physical region within the storage device, such as a database, a data table, or a data file, in which merchandise information, nutrition information, or related data is stored.

The term “merchandise information” refers to information representing one or more items of goods available for recommendation, including attributes such as price, category, style, size option, identifier, and other item-related properties.

The term “nutrition information” refers to information relating to nutritional characteristics of food or meals, such as energy amount, macronutrient components, micronutrient components, or other health-related parameters.

The term “document information” refers to textual or structured content generated by the processor by integrating structured input information and retrieval results, and formatted as content suitable for use in a prompt sentence to a generative AI model.

The term “prompt sentence” refers to a sequence of characters or tokens expressed in a natural language or a structured text format and supplied as an input to a generative AI model, the sequence encoding instructions, context, constraints, and data necessary for the model to generate an output.

The term “first prompt sentence” refers to a prompt sentence generated by the processor for input to a clothing-proposal generative AI model, the first prompt sentence including at least document information relating to budget information, preference information, and merchandise information.

The term “second prompt sentence” refers to a prompt sentence generated by the processor for input to a meal-plan generative AI model, the second prompt sentence including at least document information relating to current body information, target body information, and nutrition information.

The term “generative AI model” refers to an artificial intelligence model, such as a neural network-based language model, that is configured to generate new content, including text, based on an input prompt sentence and internal parameters learned from training data.

The term “clothing-proposal generative AI model” refers to a generative AI model configured to receive the first prompt sentence and to output clothing proposal information that reflects budget information, preference information, and body-related information.

The term “meal-plan generative AI model” refers to a generative AI model configured to receive the second prompt sentence and to output meal plan information that reflects current body information, target body information, and nutrition-related constraints.

The term “clothing proposal information” refers to information generated by the clothing-proposal generative AI model, including at least one proposed merchandise item or combination of merchandise items, and optionally descriptive text, that satisfies predetermined conditions such as budget and preference.

The term “meal plan information” refers to information generated by the meal-plan generative AI model, including a schedule or list of meals, possibly by day and by meal, with associated nutritional guidance or energy amounts, for guiding a user from current body information toward target body information.

The term “response information” refers to information generated by the processor by integrating clothing proposal information and meal plan information, and formatted for transmission to and display on the terminal.

The term “attribute information” refers to one or more properties of a merchandise item, such as name, category, style, size, price, or other descriptive or functional characteristics.

The term “price condition” refers to a constraint relating to monetary value, such as a maximum allowable price or a price range that merchandise information must satisfy.

The term “preference condition” refers to a constraint relating to user preference, such as a required category, style, or other preference-related criterion that merchandise information must satisfy.

The term “nutrition requirement information” refers to information calculated based on current body information and target body information, the information indicating recommended or target amounts of energy or nutrients over a given period.

The term “natural language” refers to a language used for human communication, such as an everyday textual language, which is expressed as sentences or phrases understandable by a generative AI model trained on such language.

In one embodiment, a server cooperates with at least one terminal operated by a user to implement a recommendation system that generates clothing proposal information and meal plan information using a generative AI model. The server includes at least one processor, a main memory, a non-volatile storage device, and a network interface. The processor can be implemented as a central processing unit or a combination of a central processing unit and a graphics processing unit, and the storage device can be implemented as a magnetic disk, a solid-state drive, or a network-attached storage. The server executes server-side software implemented, for example, using a web framework such as a server-side scripting framework, a database management system such as a relational database, and a model-serving framework such as a deep learning inference engine.

The terminal is implemented as a computing apparatus such as a mobile device, a tablet, or a desktop client. The terminal executes client software, for example, a native application framework or a web browser framework, and displays a graphical user interface that allows the user to input budget information, preference information, current body information, and target body information. The terminal transmits the input information to the server over a secure communication channel, and the terminal receives response information and displays clothing proposal information and meal plan information on a display unit.

The server stores structured information in a database management system. The server represents user-related data as records in relational tables or as documents in a document-oriented store. For example, the server stores budget information as a numeric field, preference information as a categorical or textual field, and body-related information as structured attributes such as body size category and optional anthropometric values. The server also stores merchandise information, including price, category, style, and available sizes, and nutrition information, including energy values and macronutrient information, in separate tables that are indexed for efficient retrieval.

The server converts input information received from the terminal into structured information using a defined data schema. The server maps each element of the input information into a corresponding field of a data record and stores the record in the storage device. By normalizing heterogeneous user inputs into a consistent schema, the server improves data management and allows the processor to perform indexed queries on the merchandise information and the nutrition information. This data structuring reduces redundant parsing and validation on subsequent requests and enhances the calculation efficiency of the system.

The server retrieves merchandise information and nutrition information based on the structured information. The server uses filtered queries, for example range filters on price and equality filters on preference categories, to retrieve only those merchandise items that satisfy a price condition and a preference condition. The server also retrieves nutrition entries that are relevant to a user's body condition and target condition. The server performs aggregations and joins at the database level to pre-compute subsets of candidate clothing items and candidate food items before invoking any generative AI model. By offloading part of the computation to optimized database query engines, the server reduces the processing load of the generative AI model and decreases overall response time.

The server generates document information by integrating structured input information and retrieval results. The server constructs intermediate data structures that combine user constraints (for example, budget and style preference) with attribute information of candidate merchandise items and with nutrition information derived from a nutrition database. The server formats these intermediate data structures into a structured representation that preserves relationships between user constraints and item attributes. This integration step allows the server to produce context-rich input to the generative AI model and avoids repeatedly transmitting large unstructured datasets over the network.

The server generates at least one prompt sentence for a generative AI model. In one embodiment, the server generates a first prompt sentence to be input to a clothing-proposal generative AI model and a second prompt sentence to be input to a meal-plan generative AI model. The server converts the document information into natural language text that is optimized for the internal tokenization and attention mechanism of the generative AI model. For example, the server may format the first prompt sentence as:

“The user's budget is 5000 yen, the clothing preference is casual, the current body type is L size, and the target body type is M size. The following clothing items are available within the budget: Item 1: casual shirt, price 3000 yen, sizes M and L; Item 2: casual pants, price 4500 yen, sizes L and XL. Based on these conditions and available items, please propose one or more sets of casual clothing that fit the current body type and are suitable for a user who aims to reach an M size.”

The server may format the second prompt sentence as:

“The user's current body type is L size and the target body type is M size. The user prefers a healthy diet without extreme restrictions. Based on this information and the following nutrition data: typical daily energy intake for maintaining L size is 2200 kcal; recommended daily energy intake for moving toward M size is 1700 to 1900 kcal; please propose a 7-day meal plan. For each day, specify breakfast, lunch, and dinner, provide an approximate calorie count for each meal, and ensure that the plan is safe and sustainable.”

The server implements the generative AI models as neural network models that are trained and deployed in a model-serving environment. In one embodiment, the server uses a transformer-based neural network architecture that includes an embedding layer, multiple self-attention layers, and feed-forward layers. The server stores learned parameters of the neural network, such as weight matrices and bias vectors, in the storage device, and the server loads these parameters into memory during inference. The clothing-proposal generative AI model is trained on text data that includes descriptions of clothing items, style categories, and constraints, while the meal-plan generative AI model is trained on text data that includes dietary guidelines, meal examples, and nutritional information.

The server trains the generative AI models using a supervised learning process. The server defines a loss function, for example a cross-entropy loss between predicted tokens and reference tokens, and the server updates model parameters using a gradient-based optimization algorithm, such as stochastic gradient descent or an adaptive moment estimation algorithm. The server may augment training data by applying data augmentation techniques, such as paraphrasing, synonym replacement, or style variation, to increase robustness of the model to different phrasings of prompt sentences. By training the models on large corpora and by optimizing the parameters for conditional text generation, the server enables the generative AI models to produce coherent and accurate clothing proposals and meal plans.

The server uses specific internal features and attention patterns of the generative AI models to capture relationships between budget constraints, style preferences, and item attributes, as well as relationships between body conditions and nutritional needs. For example, the server provides explicit tokens denoting budget thresholds, style labels, and body size indicators in the prompt sentences so that the transformer attention mechanism can attend to these constraint tokens when predicting output tokens. This non-conventional encoding of constraints into natural-language prompt sentences allows the generative AI model to compute recommendations that simultaneously satisfy multiple constraints without executing separate rule-based filters for each constraint.

The server processes the outputs of the generative AI models by parsing the generated text into structured clothing proposal information and meal plan information. The server uses parsing logic, including pattern matching on day names, meal labels, and numerical expressions, to convert natural language into structured records. This parsing is implemented as deterministic algorithms that operate on the token sequence output by the generative AI model. By converting unstructured generated text into structured information, the server reduces ambiguity and enables efficient indexing and caching of recommendations.

The server integrates the clothing proposal information and the meal plan information into response information suitable for transmission to the terminal. The server may assign identifiers to recommended merchandise items for later retrieval, and the server may compute summary metrics such as total daily energy intake or distribution of styles across recommended outfits. The server encodes the response information in a machine-readable format and transmits it over the network interface to the terminal. By centralizing the integration and summary processing on the server, the system reduces processing requirements for the terminal and ensures consistent formatting across different types of terminals.

The terminal receives the response information and displays the clothing proposal information and the meal plan information in coordinated views. The terminal may visually indicate, for example, which clothing items are recommended for the current body type and which items are suitable after approaching the target body type. The terminal may also display a daily schedule of meals with approximate calories. By presenting this information in a unified interface, the terminal allows the user to evaluate clothing choices and diet plans simultaneously.

The server improves computer technology by optimizing data flows and computational workloads between the server and the terminal and between database queries and generative AI inference. The server avoids repeatedly sending large raw product catalogs or unfiltered nutrition datasets to the generative AI model and instead pre-filters and structures the information. This approach reduces the number of tokens in the prompt sentences, lowers the computational load in the generative AI model, and decreases inference time. The server also reduces network bandwidth consumption because the terminal only receives processed response information rather than large unfiltered datasets.

The server further improves the stability and reproducibility of results by systematically generating prompt sentences according to a defined template and schema rather than allowing arbitrary ad hoc prompts from the terminal or user. The server encodes structural markers, such as explicit labels for constraints and item attributes, into the prompt sentences. This structured prompting is a non-conventional technique that makes use of the architecture of the generative AI model to achieve more stable attention distributions and reduces variability of the outputs. As a result, the system improves the accuracy and consistency of recommendations compared to a system in which the generative AI model is accessed directly by the user with unstructured prompts.

The server implements a modular architecture in which different generative AI models, such as a clothing-proposal generative AI model and a meal-plan generative AI model, are used in a coordinated manner. The server may run these models on separate hardware accelerators, such as different graphics processing units, and may schedule inference jobs in parallel. The server uses asynchronous communication and batching of multiple prompt sentences to improve throughput and hardware utilization. This design leads to improved processing speed and scalability compared to systems where a single model handles all tasks sequentially.

The server employs monitoring and feedback mechanisms that track performance metrics, such as average inference time per prompt, number of tokens processed, and success rates of parsing. The server adjusts parameters of the prompt construction, such as the level of detail of item descriptions or the number of candidate items included, to balance between computation cost and output quality. This dynamic adjustment is performed according to rules and optimization criteria encoded in the server, and it affects how the server uses computational resources, resulting in measurable technical benefits such as reduced latency and reduced memory usage.

The server uses the generative AI models in a manner that is not a mere automation of human mental processes. A human operator would typically not be able to process large, heterogeneous datasets with the same efficiency, nor would a human be able to systematically adjust token-level representations, attention patterns, and numerical hyperparameters to optimize throughput and accuracy. The server's processing includes specific algorithms for building and parsing prompt sentences, organizing data structures for efficient indexing, and distributing workloads across multiple computational units. These techniques improve the technical functioning of the server and its cooperation with the terminal and the storage device.

The system can be implemented in multiple alternative embodiments. In one variation, the server uses a single generative AI model with distinct control tokens to differentiate between clothing proposal generation and meal plan generation, instead of two separate models. In another variation, the server pre-computes embeddings of merchandise attributes and body-related attributes, and the server incorporates these embeddings into the prompt sentences as serialized vectors or encoded tags. In yet another variation, the server employs a hybrid rule-based and learning-based algorithm in which deterministic filters ensure hard constraints, such as maximum budget, while the generative AI model determines soft attributes such as aesthetic compatibility or dietary variety. These variants maintain the core concept of server-side generation and processing of optimized prompt sentences and integrated response information while allowing different hardware-software configurations. By structuring data, pre-processing retrieval results, generating constraint-aware prompt sentences, and coordinating multiple generative AI models, the server achieves technical effects including improved processing speed, higher recommendation accuracy, reduced communication overhead, and improved utilization of computational resources. The server thereby provides an improved computer-implemented technique that enhances the functioning of the underlying computer system rather than merely automating a human cognitive process.

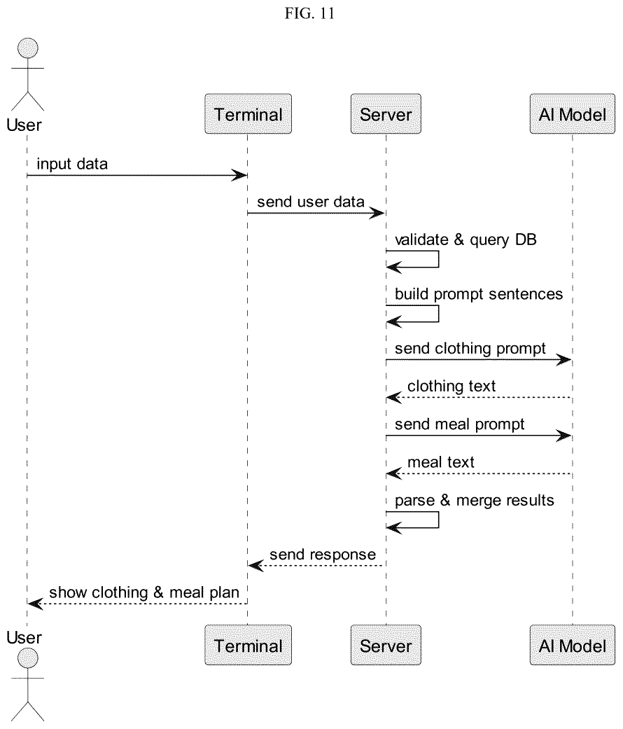

The following describes the processing flow using FIG. 11.

### Step 1

The user operates the terminal and opens an application that provides an input screen for budget information, preference information, current body information, and target body information. The input to this step is the user's intent to receive recommendations. The terminal displays text fields, dropdown lists, and selection controls generated by a user interface framework. The user enters values such as a numeric budget, a style preference, a current body size, and a target body size. The output of this step is raw input values held in the terminal's memory as user interface control states.

### Step 2

The terminal converts the raw input values into a structured data object. The input to this step is the set of UI control states containing the user's entries. The terminal validates required fields, converts string representations of numbers into numeric types, and normalizes categorical values such as style labels. The terminal then assembles these validated values into a structured record with fields for budget information, preference information, current body information, and target body information. The output of this step is a structured input object ready for transmission to the server.

### Step 3

The terminal serializes the structured input object into a transmission format and sends it to the server. The input to this step is the structured input object generated in Step 2. The terminal uses a serialization library to convert the object into a text-based representation and encapsulates the serialized data in a request message. The terminal then invokes a communication interface to send the request over a network to the server. The output of this step is a network-coupled request containing the user's input information in a structured format that can be received by the server.

### Step 4

The server receives the request and reconstructs the structured input information. The input to this step is the serialized request message transmitted from the terminal. The server's network interface accepts the message, and the server invokes a parsing routine to extract the serialized content. The server deserializes the content back into an internal data structure representing budget information, preference information, current body information, and target body information. The output of this step is an internal structured record stored in the server's working memory.

### Step 5

The server validates and normalizes the structured input information. The input to this step is the internal structured record from Step 4. The server verifies that the budget value is within a permissible numerical range, that the preference value belongs to an allowed set of categories, and that the body information fields conform to defined formats. The server may perform unit conversions or mapping of size labels to internal codes. The server updates the record to reflect any normalized values. The output of this step is a validated and normalized user profile record.

### Step 6

The server stores the validated user profile record in a storage device. The input to this step is the normalized user profile record from Step 5. The server uses a data access module to map fields of the record to columns or attributes of a persistent data structure and writes the record to an information storage region such as a table or collection. The server also assigns an internal identifier to the record for later reference. The output of this step is a stored user profile entry and an in-memory reference to that entry.

### Step 7

The server retrieves merchandise information that satisfies the budget and preference constraints. The input to this step is the normalized user profile record including budget information and preference information. The server constructs a query specifying a price condition (for example, price less than or equal to the budget value) and a preference condition (for example, style category equal to the selected preference). The server executes this query against a merchandise information repository. The output of this step is a collection of merchandise records that meet the specified price condition and preference condition.

### Step 8

The server retrieves nutrition information relevant to the current body information and the target body information. The input to this step is the normalized user profile record including current body information and target body information. The server calculates or looks up data such as recommended daily energy intake and nutrient distribution for moving from the current condition toward the target condition. The server queries a nutrition information repository to obtain entries that match these calculated requirements. The output of this step is a set of nutrition entries and associated requirement parameters.

### Step 9

The server generates integrated document information from the user profile, merchandise information, and nutrition information. The input to this step is the user profile record, the merchandise collection from Step 7, and the nutrition set from Step 8. The server merges these data structures by associating user constraints with candidate items and nutritional guidelines. The server constructs a structured representation that includes fields for user constraints, lists of item attributes, and nutritional summaries. The server then formats this structured representation into an intermediate document representation suitable for conversion into natural language. The output of this step is a unified document data structure containing integrated context.

### Step 10

The server converts the integrated document information into a first prompt sentence for a clothing-proposal generative AI model. The input to this step is the unified document data structure from Step 9. The server performs a transformation from the structured representation to natural language text by filling predefined templates with specific field values. The server arranges sentences to explicitly express the budget, preference, and item attributes. The server may output a sentence such as:

“The user's budget is 5000 yen, the clothing preference is casual, the current body type is L size, and the target body type is M size. The following clothing items are available within the budget: Item 1: casual shirt, price 3000 yen, sizes M and L; Item 2: casual pants, price 4500 yen, sizes L and XL. Based on these conditions and available items, please propose one or more sets of casual clothing that fit the current body type and are suitable for a user who aims to reach an M size.”

The output of this step is a first prompt sentence expressed as a natural-language string.

### Step 11

The server converts the integrated document information into a second prompt sentence for a meal-plan generative AI model. The input to this step is the same unified document data structure from Step 9, including body and nutrition-related information. The server uses a separate template that emphasizes current body information, target body information, and nutritional constraints. The server may output a sentence such as:

“The user's current body type is L size and the target body type is M size. The user prefers a healthy diet without extreme restrictions. Based on this information and the following nutrition data: typical daily energy intake for maintaining L size is 2200 kcal; recommended daily energy intake for moving toward M size is 1700 to 1900 kcal; please propose a 7-day meal plan. For each day, specify breakfast, lunch, and dinner, provide an approximate calorie count for each meal, and ensure that the plan is safe and sustainable.”

The output of this step is a second prompt sentence expressed as a natural-language string.

### Step 12

The server submits the first prompt sentence to the clothing-proposal generative AI model. The input to this step is the first prompt sentence from Step 10. The server packages the prompt sentence into a model input structure and sends it to a model-serving component configured to execute a generative AI model. The generative AI model processes the prompt sentence using a neural network that computes embeddings, applies multiple self-attention layers, and predicts output tokens. The output of this step is a generated text sequence representing clothing proposal information.

### Step 13

The server submits the second prompt sentence to the meal-plan generative AI model. The input to this step is the second prompt sentence from Step 11. The server packages the prompt sentence into another model input structure and sends it to a model-serving component that executes a generative AI model trained for dietary planning. The model processes tokens that encode body-related constraints and nutrition requirements and produces a sequence of output tokens. The output of this step is a generated text sequence representing meal plan information for multiple days and meals.

### Step 14

The server parses the generated clothing proposal information into a structured format. The input to this step is the generated text sequence from Step 12. The server applies a parsing algorithm that searches for patterns corresponding to item names, price values, sizes, and outfit groupings. The server may split text by line breaks or punctuation, identify keywords such as “outfit,” “top,” and “bottom,” and convert recognized segments into structured records. The output of this step is a collection of clothing proposal records, each containing fields such as recommended item identifier, description, and reasoning text.

### Step 15

The server parses the generated meal plan information into a structured schedule. The input to this step is the generated text sequence from Step 13. The server analyzes the text to identify day labels, meal labels such as “breakfast,” “lunch,” and “dinner,” and calorie values. The server uses tokenization and pattern matching to separate each day's plan and to assign each meal's description and numeric energy value to corresponding fields. The output of this step is a structured meal-plan data set containing, for each day and each meal, a description and an approximate calorie count.

### Step 16

The server integrates the structured clothing proposal records and the structured meal-plan data set into unified response information. The input to this step is the clothing data from Step 14 and the meal data from Step 15. The server creates a response structure that groups clothing proposals and meal plans under the same user profile and may also compute summary values such as the total number of recommended outfits and the range of daily energy intake. The output of this step is a response object that encapsulates both clothing proposal information and meal plan information.

### Step 17

The server transmits the unified response information to the terminal. The input to this step is the response object from Step 16. The server serializes the response structure into a transmission format and constructs a response message. The server sends this message through the network interface to the terminal. The output of this step is a transmitted response containing machine-readable data representing the recommendations.

### Step 18

The terminal receives the response message and reconstructs the response structure. The input to this step is the serialized response message from the server. The terminal's communication module accepts the message and passes the content to a deserialization routine that converts the transmission format back into internal data objects. The terminal obtains a clothing proposal list and a meal-plan schedule from these data objects. The output of this step is a set of in-memory structures representing clothing proposals and meal plans.

### Step 19

The terminal renders the clothing proposal information on a display for the user. The input to this step is the clothing proposal list from Step 18. The terminal's user interface module creates visual elements such as list items and cards to represent each recommended clothing item. The terminal may display item names, prices, size suggestions, and textual explanations. The terminal may also provide interactive controls that allow the user to select or view details of recommended items. The output of this step is a graphical representation of clothing proposals shown on the terminal's screen.

### Step 20

The terminal renders the meal plan information on a display for the user. The input to this step is the meal-plan schedule from Step 18. The terminal's user interface module generates a layout that organizes meal entries by day and by meal time. The terminal displays meal descriptions and calorie values and may allow the user to navigate between days. The output of this step is a graphical representation of the meal plan that enables the user to review and follow dietary recommendations.

### Step 21

The user reviews the displayed clothing proposals and meal plan and may perform follow-up actions. The input to this step is the visual information presented by the terminal in Steps 19 and 20. The user may decide to adjust parameters such as budget or preference based on the displayed results and may trigger another recommendation cycle by modifying input values on the terminal. The output of this step is updated interaction context that can be used by the terminal to initiate a new request to the server.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems for consumer products, such as apparel items or dietary plans, typically process user data in a fragmented manner. A first subsystem may use basic rules or simple machine learning models to suggest products based on budget and category, while a separate subsystem may propose general dietary guidance without accurately reflecting the user's concrete body shape, target body metrics, and clothing fit requirements. As a result, known systems often fail to provide coherent, end-to-end guidance that combines apparel selection, visual fit verification, and nutrition planning in a unified computational workflow.

In addition, existing systems that incorporate generative AI models generally use static, coarse-grained prompts that merely restate user preferences, without dynamically structuring input data or incorporating feedback loops in a systematic way. Such systems do not fully exploit the capability of generative AI models to jointly handle structured constraints (for example, budget limits, size constraints, or nutritional rules) and unstructured preferences (for example, style taste or subjective comfort). This leads to suboptimal or inconsistent outputs, increased need for manual post-processing by downstream components, and additional latency caused by repeated, ad hoc calls to the generative AI model.

Furthermore, although three-dimensional visualization tools and avatar-based virtual try-on technologies are known, they are often loosely coupled to recommendation engines. In many implementations, a rendering engine produces generic or pre-configured avatars that do not accurately match user-specific anthropometric parameters generated by upstream computation. This decoupling impairs the ability of the computer system to consistently transform high-level user inputs and model outputs into concrete, body-matched virtual try-on images that can be reliably used for decision making. Similar fragmentation occurs in nutrition planning, where dietary recommendations may be produced without a direct computational link to the same user body data that drives apparel sizing and avatar generation.

From a computer-technology standpoint, these deficiencies manifest as inefficient data flows, redundant computations, and lack of a unified control logic that orchestrates: (i) structured acquisition and normalization of user data, (ii) construction and iterative refinement of prompt sentences for a generative AI model, (iii) deterministic post-processing of generative outputs into catalog-linked apparel candidates and numerically consistent meal plans, and (iv) automatic parameterization of three-dimensional models for virtual try-on rendering. Consequently, processing resources in the server are not optimally utilized, error handling is complicated, and system behavior is not predictable enough for reliable large-scale deployment.

Accordingly, there is a need for an improved computer-implemented system that integrates generative AI model interaction, catalog-aware apparel selection, avatar-based virtual try-on rendering, and numerically grounded nutrition planning into a single coordinated processing pipeline. Such a system should structure and update prompt sentences to the generative AI model in a way that exploits historical feedback, should algorithmically filter and rank AI-suggested items against a catalog under budget and size constraints, and should use the same user body information to drive both avatar parameterization and energy-expenditure-based meal planning. By doing so, the system can improve the efficiency, consistency, and technical robustness of the computer processing itself, rather than merely automating a human workflow.

The specific processing by the specific processing unit 290 of the data processing device 12 in Application Example 1 is realized by the following means.

The present invention provides a server comprising a processor configured to acquire input data including budget information, preference information, and body information of a user; to construct, based on the acquired input data, a prompt sentence to be input to a generative AI model; to input the constructed prompt sentence to the generative AI model to cause the generative AI model to generate response data including apparel information satisfying budget conditions and preference conditions and nutrition intake plan information corresponding to a body target condition; to compare the apparel information included in the response data with merchandise information stored in a merchandise information storage unit, to extract apparel candidates based on price conditions and size conditions, and to rank the apparel candidates based on an evaluation value; to calculate shape parameters of a three-dimensional human body model based on the body information of the user and to input the shape parameters and three-dimensional apparel models corresponding to the apparel candidates to a three-dimensional image generation program to generate virtual try-on images; to perform numerical computation processing and rule-based processing on the nutrition intake plan information to structure the nutrition intake plan information as a meal plan on a daily basis or a period basis; and to output the ranked apparel candidates, the virtual try-on images, and the structured meal plan to a terminal device. This enables an integrated, computer-centric improvement in which a single server-side processing pipeline coordinates generative AI inference, catalog-constrained item selection, avatar parameter computation, and nutrition-plan synthesis, thereby reducing redundant computation, ensuring consistent use of user body data across different subsystems, stabilizing the format and quality of generative AI outputs through structured prompt sentences, and enhancing overall system efficiency and reliability in generating apparel recommendations, virtual try-on images, and body-goal-oriented meal plans.

The term “processor” refers to one or more hardware computation units, such as central processing units, graphics processing units, or other programmable logic devices, configured to execute instructions of software programs to perform data acquisition, data processing, and control of other components in the system.

The term “information processing apparatus” refers to an electronic device, such as a server device or computing node, that includes at least a processor and a memory and is configured to execute software for receiving, processing, and transmitting data.

The term “input data” refers to digital data obtained from a user or an external source, including at least budget information, preference information, and body information, which are used as parameters for subsequent processing by the processor.

The term “budget information” refers to data representing a monetary limit or price range specified by a user or determined by the system, which constrains the total or individual cost of apparel items to be recommended.

The term “preference information” refers to data describing a user's subjective or objective likes, dislikes, and desired characteristics, such as apparel style, color, category, or usage context, which influence the selection and ranking of apparel candidates.

The term “body information” refers to data representing physical characteristics of a user, including but not limited to height, weight, body circumferences, and target body metrics, which are used for apparel sizing, avatar parameterization, and nutrition planning.

The term “prompt sentence” refers to a text sequence or structured textual input generated by the processor and provided to a generative AI model, the text including conditions, constraints, and instructions that specify the desired type, structure, or content of the model's output.

The term “generative AI model” refers to a machine-learned model configured to generate text or structured data in response to an input prompt sentence, based on parameters learned from training data, and capable of producing apparel information and nutrition intake plan information.

The term “response data” refers to data output from the generative AI model in response to a prompt sentence, the data including at least apparel information and nutrition intake plan information generated under specified constraints.

The term “apparel information” refers to data describing clothing-related items, such as item type, style, size, material, and price, which are generated by the generative AI model or stored in a merchandise information storage unit.

The term “nutrition intake plan information” refers to data describing recommended intake of foods or nutrients for a user, including meal components, quantities, and timing, which are generated by the generative AI model based on body information and body target conditions.

The term “body target condition” refers to data representing a desired or goal state of a user's body, such as target weight, target waist circumference, or other target measurements, used as a basis for generating apparel recommendations and nutrition plans.

The term “merchandise information” refers to catalog data stored in a merchandise information storage unit, the data including identifiers, categories, prices, sizes, and other attributes of items available for purchase.

The term “merchandise information storage unit” refers to a memory or storage subsystem, such as a database or file storage, configured to store merchandise information and to allow the processor to read and compare such information.

The term “apparel candidates” refers to one or more apparel items selected or filtered from apparel information and merchandise information based on constraints such as budget, size, and user preferences, and considered as possible recommendations.

The term “price conditions” refers to constraints related to cost, including maximum or minimum allowable prices for individual items or combinations of items, which are used by the processor to filter apparel candidates.

The term “size conditions” refers to constraints relating to clothing size or fit, including available sizes and compatibility with a user's body information, which are used by the processor to filter apparel candidates.

The term “evaluation value” refers to a numerical or ordinal score computed by the processor for each apparel candidate based on factors such as preference match, popularity, availability, and cost, and used for ranking apparel candidates.

The term “shape parameters” refers to numerical values or data describing geometric or proportional characteristics of a three-dimensional human body model, such as scaling factors or morphing coefficients, derived from a user's body information.

The term “three-dimensional human body model” refers to a digital representation of a human body in three-dimensional space, including mesh and skeleton data, which can be adjusted by shape parameters to approximate a specific user's body.

The term “three-dimensional apparel model” refers to a digital three-dimensional representation of an apparel item, including geometric and appearance data, which can be combined with a three-dimensional human body model for virtual try-on rendering.

The term “three-dimensional image generation program” refers to software, such as a three-dimensional graphics engine or rendering program, configured to generate images or animations by rendering three-dimensional human body models and three-dimensional apparel models based on input parameters.

The term “virtual try-on images” refers to digital images or sequences of images that visually represent a three-dimensional human body model wearing one or more three-dimensional apparel models, allowing visual confirmation of fit and appearance.

The term “numerical computation processing” refers to processing in which the processor performs arithmetic operations, such as calculations of energy expenditure, caloric targets, or nutrient distributions, based on body information and nutrition intake plan information.

The term “rule-based processing” refers to processing in which the processor applies predetermined logical rules or constraints, such as nutrient distribution rules or intake restriction conditions, to select, filter, or restructure nutrition intake plan information.

The term “meal plan” refers to structured data representing a sequence of meals organized on a daily or period basis, each meal specifying one or more food items and associated nutritional properties, constructed from nutrition intake plan information.

The term “terminal device” refers to an electronic device operated by a user, such as a portable device, a head-mounted device, or a general-purpose computing device, which communicates with the server to send input data and receive apparel candidates, virtual try-on images, and meal plans.

The term “history information” refers to data representing past interactions between the user and the system, including user selections, acceptances, and rejections of apparel candidates or meal plans, which are used to update and refine subsequent prompt sentences.

The term “preference information of the user with respect to apparel candidates” refers to history information indicating which apparel candidates the user has positively evaluated, selected, or frequently chosen in prior interactions.

The term “rejection information of the user with respect to apparel candidates” refers to history information indicating which apparel candidates the user has negatively evaluated, discarded, or avoided in prior interactions.

The term “nutrient distribution rules” refers to predetermined guidelines or constraints that specify target proportions or ranges for nutritional components, such as protein, fat, and carbohydrate, used by the processor to construct or refine a meal plan.

The term “intake restriction conditions” refers to constraints that limit or prohibit certain nutritional components, ingredients, or food types, such as maximum caloric intake, allergen avoidance, or dietary style restrictions, applied during meal plan construction.

The term “energy expenditure” refers to an amount of energy, typically expressed in units of calories or joules, calculated from body information and activity assumptions, indicating the energy consumed by a user's body over a period.

The term “meal candidate information” refers to data describing individual meal options or food combinations output from the generative AI model, from which the processor selects and arranges elements to construct a final meal plan.

In one embodiment, a server includes at least one processor, a memory, a network interface, and a storage device. The server executes an operating system such as a generic server operating system and an application program implemented, for example, using a scripting language runtime and associated libraries. The server communicates with at least one terminal via a network such as the Internet or a local area network. The terminal includes at least one processor, a memory, a display unit, and one or more input units such as a touch panel or physical buttons. The user operates the terminal to input information and to view results.

The server stores program modules in the memory and the storage device. The program modules include a data acquisition module, a prompt construction module, a generative AI interface module, a catalog matching and ranking module, a three-dimensional avatar parameterization module, a three-dimensional rendering interface module, and a nutrition planning module. Each module processes digital data using specific data structures and algorithms so as to improve the efficiency and consistency of apparel recommendation, virtual try-on generation, and nutrition planning.

The terminal presents one or more user interface screens implemented, for example, using a native application framework. The terminal displays input fields for budget information, preference information, and body information. The user enters, via the terminal, values such as a target budget amount, preferred apparel styles, and current and target body measurements. The terminal converts these values into a structured internal representation, for example, a set of key-value pairs stored in memory, and transmits this representation to the server through the network interface using a communication protocol such as HTTP over a secure channel.

The server receives the transmitted data at the data acquisition module. The server validates the data types and ranges and stores the normalized data into a structured data store, such as a relational database, where the data are held in tables corresponding to user profile data, body measurement data, and preference history data. The server uses indexing structures in the database to enable efficient retrieval of user-related records when constructing subsequent prompt sentences and when performing catalog matching operations.

The server constructs, in the prompt construction module, a prompt sentence as a textual instruction to a generative AI model. The server selects, from the stored user data, fields such as budget information, preference information, and body information. The server combines these fields with fixed instruction templates stored in the memory. The templates specify, for example, that the generative AI model is to output structured apparel information and nutrition intake plan information. The server concatenates the fixed instruction text and the user-specific values into a single prompt sentence string.

The server, in one concrete example, constructs a prompt sentence as follows:

“The user's budget is 10,000 yen, the preferred clothing style is casual, the current waist size is 80 cm, and the target waist size is 75 cm. Based on this information, recommend a set of clothing items within the budget and generate a 14-day meal plan that supports reaching the target waist. Return the result as text describing specific clothing items and daily meals.”

The server, in another example after the user provides feedback, constructs a refined prompt sentence:

“The user has a budget of 8,000 yen, prefers sporty casual outfits, dislikes bright colors, has a current waist of 85 cm, and wants to reduce it to 78 cm. Recommend a top, bottom, and shoes that match these preferences and remain within the budget, and generate a 7-day meal plan focused on high-protein, low-fat dishes suitable for a Japanese diet. Describe each clothing item and each meal in detail.”

The server supplies the constructed prompt sentence to the generative AI model through the generative AI interface module. In one embodiment, the generative AI model is implemented as a neural network of the transformer type, which is trained in advance on large-scale text datasets. The neural network includes an embedding layer that converts input tokens into dense vectors, a plurality of self-attention layers and feed-forward layers that process sequences of vectors, and an output layer that generates probability distributions over tokens. The server transmits the prompt sentence to this model via an application programming interface.

The server, during training of such a generative AI model in a development environment, uses a loss function such as cross-entropy loss between predicted tokens and correct tokens, and updates model parameters (weights and biases) with an optimization algorithm such as stochastic gradient descent or a variant thereof. The server may apply data augmentation techniques, such as paraphrasing of textual conditions and random masking of parts of input sentences, to increase robustness of the model to variations in prompt sentences. In a deployment environment, the model parameters are fixed, and the model deterministically generates response sequences based on the prompt sentence and specified decoding parameters such as temperature, top-k sampling, or beam width.

The server receives the response text from the generative AI model. The response text includes a description of apparel items and a provisional nutrition intake plan. The server parses the text using rule-based parsing logic and, in some implementations, a secondary lightweight natural language processing model. The server converts the response into internal structured data objects. For example, the server extracts apparel item names, categories, price indications, size indications, and style descriptions into records in a temporary apparel suggestion table, and extracts daily meal descriptions, portion indications, and qualitative nutritional hints into records in a temporary meal plan table.

The server accesses a merchandise catalog stored in the merchandise information storage unit. The merchandise catalog is implemented, for example, as a relational database or a document-oriented database, where each apparel item is represented as a record including fields such as item identifier, category, style tags, available sizes, price, and links to three-dimensional apparel models. The server performs matching between the apparel information generated by the generative AI model and the merchandise catalog. The server computes similarity scores between textual descriptions from the model and catalog attributes using vector representations such as word embeddings or sentence embeddings. The server then selects one or more concrete catalog items that best correspond to each suggested apparel item from the model.

The server applies price conditions and size conditions when determining apparel candidates. The server computes, for each potential combination of items, the total cost and checks that the total does not exceed the user's budget. The server also verifies that each selected item is available in a size compatible with the user's body information, using size charts and mapping rules stored in the database. The server discards combinations that violate price conditions or size conditions. The server then assigns, to each remaining apparel candidate or outfit, an evaluation value. The evaluation value is computed from multiple features, including similarity to user preference tags, similarity to the generative AI suggestion, stock availability, and normalized price attractiveness. The server may use a scoring function such as a weighted linear combination or a learned regression model to compute this evaluation value.

The server ranks the apparel candidates in descending order of evaluation value. Because the server uses pre-indexed catalog data and vectorized operations on arrays of candidate features, the ranking process is accelerated compared to naive item-by-item evaluation. This improves processing speed and reduces server load when handling many concurrent users.

The server uses the three-dimensional avatar parameterization module to transform the user's body information into shape parameters for a three-dimensional human body model. The server stores a base mesh and skeleton representing a generic human body in a three-dimensional model format. The server associates with the base mesh a set of morph targets or blend shapes that enable local adjustments such as waist circumference, chest circumference, and limb lengths. The server calculates morph coefficients by applying formulas that map measured body values (e.g., waist size) to shape parameter ranges. The server may further apply skeletal scaling factors to adjust overall body height and limb proportions.

The server uses the three-dimensional rendering interface module to communicate with a three-dimensional image generation program running on the server or on a connected computing resource. The server transmits to the three-dimensional image generation program a configuration including the shape parameters of the human body model and identifiers of three-dimensional apparel models corresponding to the apparel candidates. The three-dimensional image generation program loads the body model and apparel models, applies the shape parameters to deform the body model, and attaches apparel meshes to appropriate bones or body segments using skinning techniques.

The server instructs the three-dimensional image generation program to render virtual try-on images for each apparel candidate. The server sets camera viewpoints, lighting conditions, and background parameters so that images are produced in a standardized format suitable for display on the terminal. The three-dimensional image generation program executes rendering algorithms, such as rasterization or ray-based techniques, to compute two-dimensional images from three-dimensional scenes. The server receives or retrieves the rendered images from a storage area and associates the image identifiers with the corresponding apparel candidate records.

The terminal receives, from the server, the ranked apparel candidates and corresponding virtual try-on images. The terminal displays the candidates as a list or grid view with textual descriptions and thumbnail images. When the user selects a candidate, the terminal displays the larger virtual try-on images rendered from one or more viewpoints. The user visually evaluates fit and style based on these images. Because the three-dimensional avatar is parameterized with precise body measurements derived from the user's body information, the virtual try-on images provide a more accurate visualization than generic, non-personalized avatars, thereby improving the user's decision-making ability.

The server uses the nutrition planning module to transform nutrition intake plan information into a concrete meal plan. The server calculates, from the user's current and target body information, an estimated basal metabolic rate and total daily energy expenditure using known physiological formulas. The server determines a daily caloric target and a macronutrient distribution (e.g., percentage of calories from protein, fat, and carbohydrates) based on stored rules and optionally on user-specified dietary preferences. The server, using numerical computation libraries and structured food databases, selects food items and meal combinations that satisfy the caloric and macronutrient constraints within predefined tolerances.

The server compares the provisional meals suggested by the generative AI model with items in the structured food database. The server identifies database entries whose nutritional profiles align with the qualitative descriptions provided by the model. The server adjusts portion sizes and compositions so that the resulting meals meet the target nutrient distribution. The server arranges meals into a schedule on a day-by-day basis for a specified period, such as seven or fourteen days. The server thus converts the model's text-level plan into a numerically grounded, structured meal plan that is consistent with the same body information used for apparel sizing and avatar construction.

The server transmits the structured meal plan to the terminal. The terminal displays the meal plan in a calendar or list format, allowing the user to view, for each day, the recommended meals and basic nutritional information. The user may provide feedback to the terminal, such as indicating meals that are undesirable due to ingredients or preparation constraints. The terminal transmits such feedback to the server.

The server incorporates user feedback into updated prompt sentences. The server stores, in history information tables, records representing user selections of apparel candidates and acceptance or rejection of meals. The server uses this history information to generate additional preference information and rejection information. When constructing later prompt sentences, the server includes this historical context, for example, by adding text such as “The user prefers looser tops and darker colors and has rejected bright-colored items in the past” or “The user avoids dairy products and prefers high-protein dishes.” This feedback loop allows the generative AI model to produce more targeted suggestions in subsequent interactions, and it does so through a specific dataflow and prompt-updating algorithm that operates within the server.

From a computer-technology perspective, the server improves processing speed and accuracy by tightly coupling generative AI output with deterministic catalog matching, numerical computations, and three-dimensional rendering. The server does not merely automate a human stylist's workflow; instead, the server introduces machine-specific operations and data structures that are impractical or impossible for a human to perform manually at scale. For example, the server computes embedding-based similarity between large sets of catalog items and model-generated descriptions, performs multi-constraint optimization over price and size conditions, and parameterizes three-dimensional avatar meshes in real time. These operations result in technical effects such as reduced computation redundancy, improved cache efficiency in database access through pre-structured keys and indices, and lower communication load between the server and the terminal due to transmission of compact structured data rather than raw, unfiltered catalog information.

The server further improves the robustness of the generative AI model's integration by enforcing structured prompt formats and deterministic post-processing rules. By specifying, in the prompt sentence, how the model is to structure its textual output and by validating and normalizing the model's output using dedicated parsing logic, the server reduces error rates and variability in system behavior. This, in turn, decreases the need for repeated model calls to correct malformed outputs, thereby reducing latency and compute consumption. The server also uses control parameters of the neural network (such as maximum token length and decoding strategy) in a manner tuned to the target tasks, improving the balance between response quality and inference time.

In another embodiment, the server may host multiple generative AI models or different configurations of a transformer-based model. The server can select, for example, a smaller model configuration for low-latency scenarios or a larger model configuration for high-precision recommendations. The server may route different prompt sentences to different model instances based on task type, such as routing apparel-focused prompts to a model fine-tuned on fashion-related data and nutrition-focused prompts to a model fine-tuned on dietary data. This modular configuration enables scalable deployment while maintaining technical efficiency.

In yet another embodiment, the server may execute the three-dimensional image generation program locally on a specialized hardware accelerator, such as a graphics processing unit, to accelerate rendering of virtual try-on images. The server may use a compressed representation of three-dimensional apparel models, such as simplified meshes or level-of-detail variants, to reduce computational load, and may dynamically select the appropriate level of detail based on network conditions or display resolution of the terminal. These optimizations contribute to reduced end-to-end latency and lower resource utilization.

In all of these embodiments, the terminal remains relatively simple, handling mainly user interaction and rendering of outputs. The majority of computational complexity resides in the server, where specialized modules coordinate the generative AI model interaction, catalog matching, avatar parameterization, and nutrition planning. By defining explicit data structures, algorithms, and inter-module interfaces, the server achieves a concrete technical improvement in how computer systems process heterogeneous user data to generate integrated apparel recommendations, accurate virtual try-on images, and body-goal-oriented meal plans.

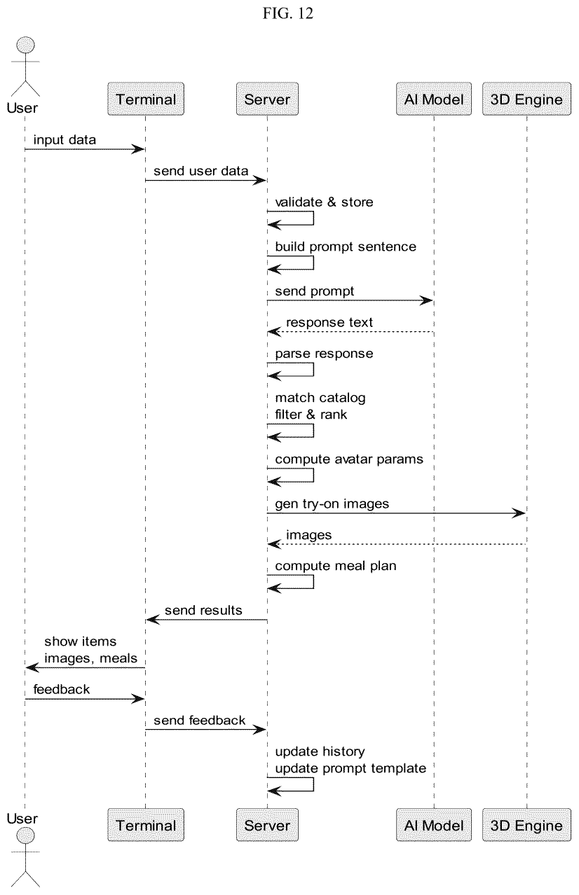

The following describes the processing flow using FIG. 12.

### Step 1

The terminal displays an input screen that includes fields for budget information, preference information, and body information.

The user enters, via the terminal, values such as a budget amount, preferred clothing style, current body measurements, and target body measurements.

The terminal uses the entered values as input, performs local validation processing by checking data types and value ranges, and generates a structured input object as output, for example, a set of key-value pairs representing budget, preferences, and body metrics.

### Step 2

The terminal transmits the structured input object to the server through a network connection.

The server receives, as input, the structured input object from the terminal via a communication interface.

The server performs data normalization and validation processing on the received input by converting units where necessary, checking mandatory fields, and storing the normalized values in a user profile record; the server outputs a validated and normalized user data record stored in a database.

### Step 3

The server retrieves, as input, the normalized user data record from the database, including budget information, preference information, and body information.

The server executes a prompt construction process that reads fixed instruction templates from memory and inserts the user-specific values into placeholder positions in the templates.

The server concatenates these elements, applies formatting rules such as sentence ordering and delimiter insertion, and outputs a complete prompt sentence as a text string configured for use by a generative AI model.

### Step 4

The server uses the constructed prompt sentence as input to a generative AI interface module.

The server transmits the prompt sentence, along with model configuration parameters, to a generative AI model implemented as a transformer-based neural network.

The server receives, as output from the generative AI model, response text that describes provisional apparel suggestions and a provisional nutrition intake plan; the server stores this response text in memory for further processing.

### Step 5

The server supplies, as input, the response text from the generative AI model to a parsing module.

The server performs text parsing and extraction processing by applying rule-based patterns and tokenization to identify apparel descriptions (such as item type, style, price indication, and size indication) and nutrition descriptions (such as meal names, ingredients, and qualitative nutrition hints).

The server outputs two structured data sets: an apparel suggestion list containing apparel description records and a provisional meal plan list containing meal description records.

### Step 6

The server uses the apparel suggestion list as input and accesses a merchandise catalog stored in a merchandise information storage unit.

The server performs catalog matching processing by calculating similarity between model-generated apparel descriptions and catalog item attributes, using vector representations and similarity metrics.

The server filters catalog items based on category and style similarity and outputs, for each suggested item, one or more matched catalog items represented as apparel candidate records with concrete identifiers, prices, sizes, and associated three-dimensional model references.

### Step 7

The server uses, as input, the apparel candidate records, the user's budget information, and size-related body information.

The server executes constraint filtering processing by computing total prices of item combinations and verifying that the totals do not exceed the user's budget, and by checking that available sizes for each item are compatible with the user's body measurements according to stored size mapping rules.

The server discards incompatible items or combinations and outputs a filtered set of apparel candidates that satisfy both price conditions and size conditions.

### Step 8

The server uses the filtered apparel candidates and preference-related features as input to a ranking module.

The server computes, for each apparel candidate, an evaluation value by aggregating multiple features, such as similarity to user preferences, similarity to the generative AI suggestions, stock availability, and normalized price, using a predefined scoring function.

The server sorts the apparel candidates in descending order of evaluation value and outputs a ranked apparel candidate list for presentation and for subsequent virtual try-on processing.

### Step 9

The server uses, as input, the user's body information (including current body measurements) and a base three-dimensional human body model stored in a model repository.

The server calculates shape parameters by mapping numerical body measurements to morph coefficients and skeletal scaling factors according to stored transformation functions.

The server outputs a set of shape parameter values that define how the base three-dimensional human body model is to be deformed to approximate the user's body.

### Step 10

The server supplies, as input, the shape parameter values and identifiers of three-dimensional apparel models corresponding to the ranked apparel candidates to a three-dimensional image generation program.

The server instructs the three-dimensional image generation program to load the base body model, apply the shape parameters, and attach the three-dimensional apparel models to appropriate body segments using skinning operations.

The server configures camera positions, lighting, and rendering parameters, and the three-dimensional image generation program outputs virtual try-on images for each apparel candidate; the server receives and stores these images along with references to the corresponding apparel candidates.

### Step 11

The server uses, as input, the provisional meal plan list from the parsing step and the user's current and target body information.

The server calculates basal metabolic rate and total daily energy expenditure using numerical formulas, computes a target daily caloric intake and macronutrient distribution, and then compares these numerical targets with the qualitative and quantitative information in the provisional meal plan.

The server selects or adjusts meals by choosing food items from a structured food database and modifying portion sizes so that daily totals meet the target ranges, and outputs a structured meal plan that specifies meals and nutritional values on a daily or period basis.

### Step 12

The server uses, as input, historical interaction data that include user selections, accepted apparel candidates, rejected apparel candidates, and modifications to prior meal plans.

The server updates preference information and rejection information by aggregating counts, computing preference scores for item attributes, and identifying patterns such as frequent rejection of specific colors or ingredients.

The server incorporates this updated history information into future prompt construction by appending or modifying text segments in the prompt sentence that describe the user's long-term preferences and constraints, and outputs an updated prompt template ready for subsequent interactions.

### Step 13

The server composes, as input, the ranked apparel candidate list, associated virtual try-on image identifiers, and the structured meal plan.

The server formats these data into a response structure containing apparel metadata, references to image resources, and day-by-day meal plan entries; the server serializes this structure into a communication format and outputs a response message to the terminal via the network interface.

### Step 14

The terminal receives, as input, the response message from the server and deserializes the contained data into internal structures.

The terminal uses the apparel metadata and image references to request and load virtual try-on images from the server or from a storage service, and uses the meal plan entries to build a displayable schedule.

The terminal outputs, on the display unit, a user interface showing the ranked apparel list with thumbnails, detailed virtual try-on images upon selection, and the structured meal plan in a daily or calendar view.

### Step 15

The user views, on the terminal, the ranked apparel list, virtual try-on images, and meal plan.

The user evaluates, based on the rendered images and displayed data, which apparel candidates are acceptable and which are undesirable, and which parts of the meal plan are appropriate or require changes.

The user provides, as output back to the terminal, explicit feedback such as item selections, rejections, and dietary adjustments; the terminal transmits this feedback as input to the server, enabling the server to update history information and to refine subsequent prompt sentences and recommendation results.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recommendation systems and health management support systems typically rely on rule-based engines or simple statistical models that treat product recommendation and health planning as separate, loosely coupled processes. In such systems, a server often executes independent modules: one module filters products based only on price and category, while another module generates generic diet or exercise advice based on coarse user profile information. These architectures suffer from several technical drawbacks when implemented on general-purpose computer systems.

First, conventional systems are not configured to construct and provide to a generative AI model a unified, context-rich prompt sentence that integrates heterogeneous data types, including structured product information, detailed user budget constraints, fine-grained preference attributes, current and target body information, and body-shape-specific rules. As a result, the generative AI model receives incomplete or poorly structured input, which leads to low-quality outputs, redundant computation, and the need for extensive post-processing on the server. This increases processor load, memory usage, and network round trips, and can cause latency that degrades user experience.

Second, existing systems generally do not perform an integrated pre-selection of candidate products at the server side, based on both budget and style attributes, prior to invoking a generative AI model. Instead, some systems rely on the generative AI model itself to search or reason over a large, unfiltered product space described in purely textual form. This approach is computationally inefficient and can cause unnecessary use of processing resources and bandwidth, because large volumes of product data must be encoded into prompt text and transferred to the generative AI model. Moreover, such approaches often lack deterministic control over cost-related constraints, which may result in recommendations that do not respect user budget limitations.

Third, many known health management systems fail to tightly couple body information and body target information with explicit weight-difference information and time-period constraints at the time of generating the prompt sentence for the generative AI model. The absence of such structured constraints embedded in the prompt sentence can result in vague or impractical health management plans, which, from a computing standpoint, forces additional server-side refinement logic, increases code complexity, and reduces the predictability and reproducibility of system behavior.

Fourth, conventional client-server architectures often treat server-side reasoning and terminal-side presentation as separate design concerns without a clear division of labor. Servers may return raw or semi-structured text, leaving terminals to perform complex parsing and formatting operations. This architecture can increase processing requirements and memory footprint at the terminal, which is especially problematic for resource-constrained devices, and can lead to inconsistent user interfaces and increased network traffic due to repeated requests for clarification or correction.

Therefore, there is a need for a computer-implemented system that improves the way a server structures and integrates user input data, product database information, and body-shape rules into a unified prompt sentence for a generative AI model; that pre-filters candidate products efficiently using database-level constraints; and that generates, in a single coordinated process, both product proposal information and health management plan information in a form that is immediately usable by a terminal. Such improvements are needed to reduce computational load, optimize data flow between server and terminal, improve response time, and enhance the precision and consistency of the generated recommendations and plans.

The specific processing by the specific processing unit 290 of the data processing device 12 in Example 2 is realized by the following means.

The present invention provides a server comprising a processor configured to receive, from a terminal, user attribute information and preference information, structure the information as input information including budget information, product preference information, body information, and body target information, obtain, based on the input information, candidate product information that satisfies a budget condition and a product preference condition from a product information storage apparatus, obtain body rule information associated with the body information and the body target information from a body information storage apparatus, generate a prompt sentence including the input information, the candidate product information, and the body rule information, input the prompt sentence to a generative information processing model, cause the generative information processing model to generate product proposal information and health management plan information to be provided to a user, and transmit the generated product proposal information and the health management plan information to the terminal as response information formatted in a displayable form on the terminal. This enables the server to computationally integrate heterogeneous user and database information into a structured prompt sentence, delegate complex reasoning to the generative information processing model under explicit budget, style, and body-related constraints, reduce the volume of data and processing required at both the server and the terminal, and provide, in a single, coordinated server-side operation, refined product proposal information and health management plan information that are immediately usable and efficiently displayable by the terminal.

The term “user attribute information” refers to information indicative of characteristics of a user, including at least body information such as current body size, shape, or weight, and body target information such as desired body size, shape, or weight.

The term “preference information” refers to information indicative of preferences of a user regarding products or services, including at least product preference information such as style, color, or usage scene preferences.

The term “budget information” refers to information indicative of a monetary constraint specified by a user, including at least a maximum allowable expenditure for one or more products or services.

The term “product preference information” refers to information indicative of desired attributes of a product from the viewpoint of a user, including at least style, design, category, color, or usage context.

The term “body information” refers to information indicative of a current physical state of a user, including at least body shape, body size, or weight.

The term “body target information” refers to information indicative of a desired physical state of a user, including at least target body shape, target body size, or target weight.

The term “input information” refers to structured information generated by the processor, including at least budget information, product preference information, body information, and body target information.

The term “product information storage apparatus” refers to an information processing resource, including at least a memory or a database, that stores product information such as price, style, category, size, color, or body-shape suitability attributes.

The term “body information storage apparatus” refers to an information processing resource, including at least a memory or a database, that stores body rule information associated with body information and body target information.

The term “candidate product information” refers to product information selected from the product information storage apparatus as satisfying at least one condition derived from the input information, including at least a budget condition and a product preference condition.

The term “body rule information” refers to information that defines associations or rules between body information and body target information, and recommended product attributes or health-related actions corresponding to such associations.

The term “budget condition” refers to a condition that constrains candidate product information such that one or more price attributes of a product do not exceed a value specified by the budget information.

The term “product preference condition” refers to a condition that constrains candidate product information such that one or more style attributes, category attributes, or other preference-related attributes of a product match the product preference information.

The term “prompt sentence” refers to text data or a sequence of tokens generated by the processor and provided as input to a generative information processing model, the text data including at least input information, candidate product information, and body rule information.

The term “generative information processing model” refers to a computational model configured to generate output information in response to an input prompt sentence, the computational model including at least a machine learning model such as a generative AI model.

The term “product proposal information” refers to information indicating one or more products recommended to a user, including at least identifiers of products, price information, and explanatory information describing reasons for recommendation.

The term “health management plan information” refers to information indicating one or more actions or guidelines for managing health of a user, including at least diet guideline information and exercise guideline information.

The term “response information” refers to information transmitted from the server to the terminal, including at least the product proposal information and the health management plan information in a format suitable for display on the terminal.

The term “terminal” refers to an information processing device operated by a user, including at least a portable information device or a stationary information device configured to transmit user attribute information and preference information to the server and display response information.

The term “server” refers to an information processing device or a set of information processing devices configured to execute the functions of the processor as recited in the claims, including at least receiving, structuring, retrieving, generating, and transmitting information.

In one embodiment, a server, a terminal, and a user cooperate to implement the invention in a client-server architecture. The server includes at least one processor, a main memory, a non-transitory storage device, a network interface, and one or more databases implemented, for example, by a relational database management system or a key-value store. The terminal includes at least one processor, a display, an input device such as a touch screen, a memory, and a communication interface. The user operates the terminal to input information and to review recommendations and plans generated by the server.

The server uses general-purpose computing hardware, such as a multi-core central processing unit and, in some embodiments, a graphics processing unit configured to accelerate matrix operations of a neural network. The server executes an operating system and an application framework such as a web framework. The server further executes a program that implements a generative AI model interface, database access modules, data structuring modules, and response formatting modules. The terminal executes an operating system of a portable or stationary computing device, and an application program configured to present input screens and output screens, to encode user input into structured data, and to decode server responses.

The server stores product information in a product information storage apparatus. The product information storage apparatus includes a table or a collection where each record represents an item of merchandise with attributes including at least a price attribute, a style attribute, a category attribute, a size attribute, a color attribute, and one or more body-shape suitability attributes. The server stores body rule information in a body information storage apparatus. The body rule information includes mappings from combinations of body information and body target information to rules or parameters, such as which cuts, colors, or silhouettes visually emphasize or de-emphasize certain body regions, and which diet or exercise patterns are suitable for certain weight transitions.

The terminal presents input fields for user attribute information and preference information. The user operates the terminal to enter budget information, product preference information, body information (such as current body shape and weight), and body target information (such as desired body shape and target weight). The terminal converts these inputs into structured data objects by assigning each item to a field name. The terminal applies local validation, such as checking that the budget is non-negative, that the weight values lie within a reasonable range, and that required fields are not empty. The terminal then transmits the validated structured data to the server via a network.

The server receives the structured data and converts it into input information. The server normalizes textual entries by lowercasing, trimming, and mapping synonyms to canonical labels. For example, the server maps “casual style”, “relaxed casual”, and “street casual” to a canonical style label. The server stores this normalized input information in memory as a data structure that is later used to access the product information storage apparatus and the body information storage apparatus.

The server uses a database management system to retrieve candidate product information based on the input information. The server issues a query to the product information storage apparatus that selects records where the price attribute does not exceed the budget information and where the style attribute matches the product preference information. In some embodiments, the server also applies additional filters by body-shape suitability attributes so that only items tagged as suitable for the combination of body information and body target information are retrieved as candidate product information. By performing this pre-selection in the database layer, the server reduces the volume of data that must be encoded into a prompt sentence and processed by the generative AI model, which improves processing speed and decreases memory and bandwidth usage.

The server accesses the body information storage apparatus with the body information and the body target information. The server retrieves body rule information describing, for example, which garment structures visually narrow a waist for a user with broad shoulders, or which types of garments should be avoided for particular body shapes. The server also retrieves health-related rules that relate a weight difference and a time period to recommended daily calorie deficits and exercise intensities. The server stores the retrieved body rule information in a structured format such as rule identifiers and associated textual descriptions and parameters.

The server integrates the input information, the candidate product information, and the body rule information into one or more prompt sentences intended for a generative information processing model. The server converts structured fields into descriptive sentences so that the generative AI model receives context-rich text rather than raw numeric codes. For example, the server can construct a prompt sentence such as:

“User profile: Budget 10,000 yen. Preference: casual. Current body shape: broad shoulders. Ideal body shape: slim waist. Current weight: 70 kg. Ideal weight: 60 kg.

### Product Candidates

1) Casual dark V-neck top, price 3,000 yen, suitable for broad shoulders, vertical line pattern, emphasizes waist.
2) High-waisted black pants, price 6,000 yen, casual, emphasizes waist, dark color.
3) Light-colored oversized sweatshirt, price 5,000 yen, casual, increases shoulder volume.

Body-shape rules: For broad shoulders aiming for a slimmer waist appearance, prioritize vertical lines and darker colors around the waist, emphasize the waist, and avoid items that increase shoulder volume.

Task: From the product candidates, select items within the budget that fit the casual preference and visually slim the waist for a user with broad shoulders, and explain why each selected item is suitable. Then create a detailed health management plan to help the user safely reduce weight from 70 kg to 60 kg, including diet guidelines and weekly exercise recommendations.

### Output Format

(1) Product Recommendations: list selected products with name, price, and reasons.
(2) Health Management Plan: diet guidelines and exercise guidelines with concrete actions.”

In another example, the server generates a prompt sentence that focuses on budget and style:

“Please propose multiple casual clothing items that can be purchased within a budget of 10,000 yen and that suit a user with broad shoulders and a desired appearance of a slim waist. Use the following candidate items and body-shape rules to justify your selection.”

The server uses a generative information processing model implemented as a neural network, such as a transformer-based language model. The generative AI model includes an embedding layer configured to map discrete tokens of the prompt sentence into continuous vector representations, multiple self-attention layers that compute attention scores between tokens to capture context, and feedforward layers that transform intermediate representations. The model parameters, including weight matrices and bias vectors, are stored in memory. The server executes the forward pass of the model, in which the model receives the tokenized prompt sentence and computes output token probabilities step by step.

During training of the generative AI model, a training process uses supervised learning or reinforcement learning from human feedback. The training process uses a loss function, such as cross-entropy loss between predicted tokens and ground-truth tokens, and a weight update algorithm, such as stochastic gradient descent with an adaptive learning rate. The training process also uses data augmentation techniques, such as synonym replacement, paraphrasing, or random dropout of non-critical tokens, to increase robustness. In the runtime system, the server does not perform further training but uses the trained generative AI model for inference. The server applies decoding algorithms, such as beam search or top-k sampling with temperature control, to generate coherent product proposal information and health management plan information.

The server configures the generative AI model with specific constraints that are not equivalent to human rule of thumb or manual selection. For example, the server encodes, in the prompt sentence, explicit requirements that total recommended product prices must not exceed the budget information and that the style attribute and body-shape suitability attributes must satisfy defined conditions. The model is therefore guided to produce outputs that respect these constraints. The integration of database-level pre-filtering and prompt-level constraints reduces the search space that the generative AI model must explore and results in faster convergence to suitable output sequences. As a consequence, the server achieves lower average inference time and reduced computational resource consumption per request.

The server formats the output of the generative AI model into structured product proposal information and health management plan information. The server parses headings and markers in the generated text. The server separates each recommended product with its associated explanation. The server maps textual product names and attributes back to identifiers stored in the product information storage apparatus. This mapping allows the terminal to retrieve or cache images and additional metadata without transmitting large unstructured blocks of text. The server also processes the health management plan information by identifying diet guideline information, such as daily calorie targets or food categories to prioritize or avoid, and exercise guideline information, such as frequency and intensity of physical activities.

The server then constructs response information that contains structured fields for display on the terminal. The server may compress or truncate overly long descriptions while retaining key information, which reduces the payload size and improves communication efficiency. The server transmits this response information to the terminal. By limiting the transmitted data to essential items and structured fields, the server lowers network traffic and latency compared to approaches that send entire database contents or large unfiltered text blocks.

The terminal receives the response information and renders user interfaces that present the product proposal information and the health management plan information. The terminal displays lists of recommended items with names, prices, and brief justifications. The terminal may highlight recommended items that best satisfy the combination of style, budget, and body-shape goals. The terminal also presents the health management plan in structured sections, for example a daily diet schedule and a weekly exercise schedule. The user can interact with the terminal to mark favorite items or to indicate acceptance or rejection of proposals. The terminal can send feedback data back to the server, which can be used in other embodiments to refine prompt sentence construction or to fine-tune the generative AI model.

The described configuration provides a technical improvement over systems that rely on fixed rules or unstructured interaction with generative models. The server does not simply automate human decision-making heuristics. Instead, the server implements a specific computational pipeline that optimizes data representation and flow for machine processing: database-level candidate selection based on structured constraints; explicit rule retrieval from a body rule database; integration of heterogeneous data into a structured prompt sentence; and post-processing that maps generated text back to structured representations. These steps improve the efficiency of the generative AI model, reduce the number of tokens required per prompt, and shorten inference time. The reduction of token counts and irrelevant candidate items has a direct causal relationship with reduced processor load, memory usage, and energy consumption in the computing system.

In another embodiment, the server implements multiple generative AI models or multiple model configurations. The server may use a smaller, lower-latency generative AI model for product proposal information and a larger, higher-capacity generative AI model for health management plan information. The server can route sub-prompts based on content: for instance, a first prompt sentence can be generated that only includes product-related data and body-shape rules, and a second prompt sentence can be generated that only includes weight difference information and time constraints. The server then merges the outputs into a single response. This modular architecture allows the server to optimize computational resources and to scale the system under high user loads.

In another embodiment, the server maintains an index of frequent combinations of body information, body target information, budget information, and product preference information. The server uses this index to cache intermediate structures, such as candidate product information sets or partial prompt sentences. When similar user input information is received, the server retrieves the cached data and only updates differing fields before passing the updated prompt sentence to the generative AI model. This caching reduces repeated database queries and string construction operations, improving throughput and reducing server-side latency.

In some embodiments, the terminal performs partial pre-processing of user attribute information to offload work from the server. The terminal can, for example, perform local mapping of textual preferences into standardized codes and send both the original text and the standardized codes to the server. The server then uses the standardized codes directly when querying the product information storage apparatus. This division of labor reduces the amount of string normalization work needed at the server and decreases the time between receipt of user input and generation of the prompt sentence.

The described system also improves precision and consistency of recommendations. Because the server uses structured database constraints and explicit rule retrieval to construct the prompt sentence, the variability in generative AI outputs is constrained by clearly defined conditions. This reduces the risk that the generative AI model will generate recommendations outside the budget range or inconsistent with the desired body-shape effect. Furthermore, by repeatedly using a stable prompt template and by limiting candidate product information to database-backed items, the system produces outputs that are reproducible for given inputs, which is a technical advantage in terms of system reliability and testability.

The generative AI model processes information in a way that is distinct from human manual reasoning. The model operates on high-dimensional vectors representing tokens of the prompt sentence and uses attention scores to weigh contextual relevance across the entire prompt. The model thus computes non-linear combinations of user attributes, product attributes, and body rules that would be difficult to express in a fixed rule set. However, the server constrains this flexible reasoning through the design of the prompt sentence and the pre-selected candidate sets, so that the computational power of the model is directed toward evaluating a well-defined and limited set of options. This combination of structured pre-processing and model-driven reasoning constitutes a non-conventional and non-generic use of computing resources relative to standard database filtering or simple rule engines.

These embodiments demonstrate how the server, terminal, and user cooperate to implement the invention in a manner that improves computer technology itself. The system reduces data volume transmitted to the generative AI model, lowers processing load, and increases response speed, while also enhancing the precision and consistency of the outputs. The described architectures, data structures, and processing flows enable persons skilled in the art to implement the invention on various hardware and software platforms while achieving the technical effects stated above.

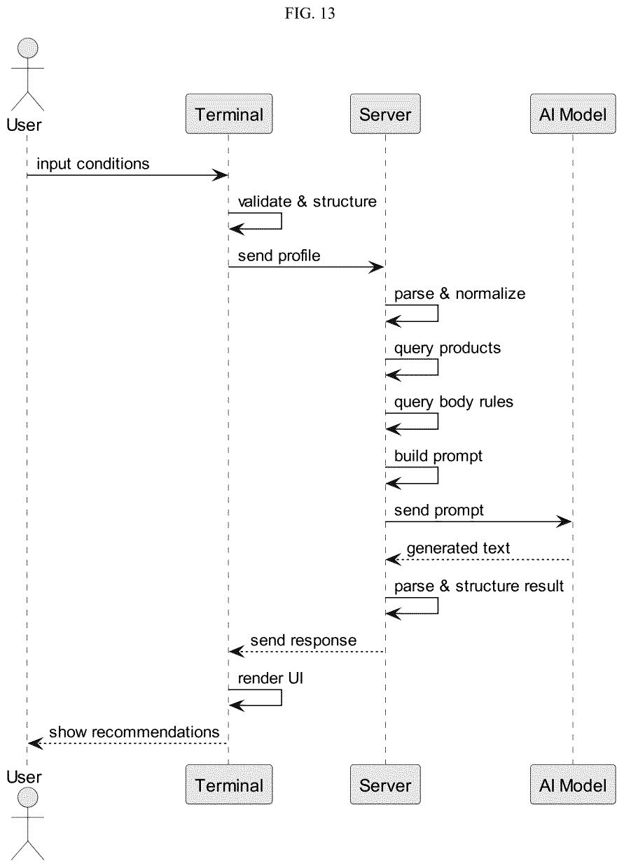

The following describes the processing flow using FIG. 13.

### Step 1

User operates the terminal to input personal conditions.

User provides, as input, budget information, product preference information, body information, and body target information through graphical input components such as text boxes, drop-down lists, and sliders.

Terminal receives these raw input values and performs local checks (e.g., ensuring budget is numeric and positive, ensuring required fields are not empty). Based on this input, terminal converts each entry into a structured internal representation, such as key-value pairs, and outputs a validated user profile object ready for transmission.

### Step 2

Terminal structures and transmits user profile data to the server.

Terminal takes, as input, the validated user profile object generated in Step 1 and performs data formatting, including mapping internal field names to a predefined schema and serializing the object into a text format suitable for network transmission.

Terminal then opens a network connection to the server, sets appropriate headers, attaches the serialized data as a request body, and outputs a network request message containing the structured user profile data.

### Step 3

Server receives and parses user profile data.

Server accepts, as input, the network request message from the terminal. Server reads the request body, deserializes the text into a server-side data structure, and verifies the presence and type of each field (budget, style, body shape, target body, current weight, target weight).

Server then normalizes textual fields by lowercasing, trimming, and mapping synonyms to canonical labels, thereby outputting normalized input information that is consistent and ready for database queries.

### Step 4

Server retrieves candidate product information from the product information storage apparatus.

Server takes, as input, the normalized input information from Step 3, including budget information and product preference information.

Server formulates a database query with conditions such as price attribute ≤budget and style attribute =preferred style. Server sends this query to the product information storage apparatus, receives matching product records, and performs additional filtering based on availability and body-shape suitability tags.

Server outputs candidate product information consisting of a subset of products that satisfy at least the budget condition and the product preference condition.

### Step 5

Server retrieves body rule information from the body information storage apparatus.

Server uses, as input, the body information and the body target information included in the normalized input information from Step 3.

Server constructs a query or key lookup for the body information storage apparatus to obtain rule sets associated with the specific combination of current body shape, target body shape, and weight difference. These rule sets may include parameters for emphasizing or de-emphasizing specific body regions and guidelines for diet and exercise.

Server outputs body rule information composed of one or more rules and associated textual descriptions and numerical parameters.

### Step 6

Server constructs a structured prompt sentence for the generative AI model.

Server takes, as input, the normalized input information from Step 3, the candidate product information from Step 4, and the body rule information from Step 5.

Server performs data aggregation and text generation: it converts structured fields into descriptive sentences, appends a list of candidate products with relevant attributes, and incorporates body-shape and health rules. Server also adds explicit constraints and instructions regarding output format.

Server outputs a prompt sentence in natural language, for example:

“User profile: Budget 10,000 yen. Preference: casual. Current body shape: broad shoulders. Ideal body shape: slim waist. Current weight: 70 kg. Ideal weight: 60 kg.

### Product Candidates

1) Casual dark V-neck top, price 3,000 yen, suitable for broad shoulders, vertical line pattern, emphasizes waist.
2) High-waisted black pants, price 6,000 yen, casual, emphasizes waist, dark color.
3) Light-colored oversized sweatshirt, price 5,000 yen, casual, increases shoulder volume.

Body-shape rules: For broad shoulders aiming for a slimmer waist appearance, prioritize vertical lines and darker colors around the waist, emphasize the waist, and avoid items that increase shoulder volume.

Task: From the product candidates, select items within the budget that fit the casual preference and visually slim the waist, and explain why each selected item is suitable. Then create a detailed health management plan to help the user safely reduce weight from 70 kg to 60 kg, including diet guidelines and weekly exercise recommendations.

Output format: (1) Product Recommendations, (2) Health Management Plan.”

### Step 7

Server transmits the prompt sentence to the generative AI model and obtains generated results.

Server uses, as input, the prompt sentence constructed in Step 6. Server tokenizes the text into a sequence of tokens and feeds these tokens into the generative AI model via a model interface.

Generative AI model performs internal computations, including embedding lookup, multi-head attention, and feedforward transformations, to compute probability distributions for subsequent tokens and then generates text that describes product proposal information and health management plan information.

Server receives the generated text as output from the generative AI model.

### Step 8

Server parses and structures the generated output.

Server takes, as input, the raw text generated by the generative AI model in Step 7. Server identifies logical sections based on headings or agreed markers such as “Product Recommendations” and “Health Management Plan.”

Server splits the product recommendation section into individual product entries, extracts product names, salient attributes, and explanatory reasons, and associates them with candidate product identifiers where possible. Similarly, server splits the health management section into diet guideline information and exercise guideline information, identifying concrete actions and parameters (e.g., frequency, duration, or intensity).

Server outputs structured product proposal information and structured health management plan information.

### Step 9

Server formats and transmits response information to the terminal.

Server uses, as input, the structured product proposal information and health management plan information from Step 8. Server arranges these data into a response schema optimized for terminal display, possibly shortening excessive text and adding summary fields such as a short description per item.

Server serializes this structured response into a compact text format, sets response headers, and sends it over the network to the terminal.

Server outputs a network response message containing display-ready response information.

### Step 10

Terminal receives and decodes the response information.

Terminal takes, as input, the network response message from the server in Step 9. Terminal deserializes the response body into internal data structures, separating product lists, explanations, and health plan sections.

Terminal maps product entries to user interface components, such as list items or cards, and prepares layout data structures that define how each piece of information will appear on the screen.

Terminal outputs a set of UI-ready objects representing product proposal information and health management plan information.

### Step 11

Terminal displays recommendations and plan to the user and collects feedback.

Terminal uses, as input, the UI-ready objects generated in Step 10. Terminal renders graphical elements on the display, including product names, prices, short justifications, and sections for diet and exercise guidelines.

User views the displayed information and may interact with it by scrolling, tapping to open details, marking favorites, or indicating that certain recommendations are not suitable. Terminal detects these interactions as events and converts them into structured feedback data, such as selected product identifiers or rejected recommendation markers.

Terminal outputs this feedback data, which may be stored locally or transmitted back to the server for subsequent processing or model refinement.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recommendation systems that provide merchandise suggestions and health management plans typically treat user attributes such as budget, preference, body information, and emotion information as independent parameters and process them through fixed rule-based logic or simple statistical models. These systems suffer from several technical problems in terms of computer technology.

First, when such systems attempt to utilize a generative AI model, they often pass only coarse user attributes as free-form natural language, without constraining the model using structured candidate data retrieved from a storage device. As a result, the generative AI model tends to generate proposals that are inconsistent with actual merchandise information stored in a database, such as non-existent items, incorrect prices, or unavailable sizes. This inconsistency forces the server to execute additional correction logic or discard parts of the generated output, which increases processing time, CPU load, memory usage, and network traffic, and degrades overall system efficiency.

Second, existing systems generally do not integrate emotion state information derived from raw sensor data (such as images or audio) into a unified prompt construction pipeline. Emotion recognition, if used at all, is handled as a loosely coupled post-processing step. The lack of a structured mechanism to incorporate emotion information into the prompt sentence for a generative AI model leads to unstable outputs, redundant calls to the model, and repeated retrieval of similar candidate information from storage. This results in inefficient utilization of computing resources of the server and increases latency perceived by the user.

Third, many systems do not manage prompt sentences and outputs of generative AI models as reusable data objects in a storage device. Without such management, the server cannot efficiently adapt future prompt generation or candidate retrieval based on historical interactions, and must recompute similar recommendations from scratch for similar input patterns. This redundant computation causes unnecessary access to the storage device, repeated execution of complex model inference, and degraded throughput of the overall system.

Accordingly, there is a need for an improved computer-implemented system and method that: (i) systematically acquires structured user input information including budget information, preference information, body information, and emotion information; (ii) retrieves constrained candidate merchandise information and health information from a storage device; (iii) generates a prompt sentence that embeds the candidate information and the user information in a consistent, machine-processable format; (iv) executes a generative AI model in a way that selects from the constrained candidate information and generates health management plan information; and (v) records and reuses prompt sentences and model outputs for subsequent processing. Such a system should improve the technical operation of the server by reducing hallucinated outputs, minimizing corrective post-processing, decreasing redundant database and model accesses, and lowering end-to-end response time while maintaining consistency with underlying stored data.

The specific processing by the specific processing unit 290 of the data processing device 12 in Application Example 2 is realized by the following means.

The present invention provides a server comprising at least one processor and at least one storage device, the processor being configured to acquire, from a terminal, structured input information including budget information, preference information, body information, and emotion information of a user; obtain, from the storage device, candidate information including merchandise information and health information that is filtered according to the input information; generate a prompt sentence for input to a generative AI model, the prompt sentence embedding the candidate information together with the budget information, the preference information, the body information, and the emotion information in a predefined textual format; input the prompt sentence to the generative AI model and obtain, as an output of the generative AI model, merchandise proposal information and health management plan information that are constrained to the candidate information; acquire, from the storage device, merchandise information corresponding to merchandise identification information included in the output of the generative AI model and format the merchandise proposal information in association with the acquired merchandise information; and store, in the storage device, the prompt sentence and the output of the generative AI model and reuse the stored prompt sentence and the stored output for at least one of generation of another prompt sentence and acquisition of other candidate information in subsequent processing. This enables the server to technically improve recommendation processing by constraining generative AI output to pre-retrieved candidate information, reducing inconsistent or non-existent results, decreasing redundant database and model computations, integrating emotion-aware processing into a single prompt-generation pipeline, and thereby enhancing computational efficiency, response time, and consistency of merchandise proposal information and health management plan information within the computer system.

The term “system” refers to an arrangement including at least one processor and at least one storage device, configured to perform acquisition, processing, generation, and output of information as described in the claims.

The term “processor” refers to a hardware computing element, such as a central processing unit or logic circuitry, that is configured to execute instructions to perform operations including acquisition of input information, retrieval of candidate information, generation of prompt sentences, execution control of a generative AI model, formatting of proposal information, and storage control.

The term “storage device” refers to a non-transitory computer-readable medium, such as a semiconductor memory, magnetic storage, or optical storage, that stores data including merchandise information, health information, candidate information, prompt sentences, and outputs of a generative AI model.

The term “terminal” refers to an electronic device operated by a user, such as a portable information processing device, a head-mounted display, or another client apparatus, that is configured to transmit input information to the system and receive and present output information from the system.

The term “user” refers to a person or entity that provides input information to the system through the terminal and receives merchandise proposal information and health management plan information generated by the system.

The term “input information” refers to structured data representing one or more attributes provided by the user, including at least budget information, preference information, body information, and emotion information, and optionally including sensor-derived data such as image information or audio information.

The term “budget information” refers to data indicating an allowable or intended expenditure range or maximum amount for acquisition of merchandise, expressed in a numerical or categorical form.

The term “preference information” refers to data indicating a tendency or liking of the user regarding at least one of style, design, category, or other characteristic of merchandise or lifestyle.

The term “body information” refers to data representing physical characteristics of the user, including at least one of body size, body shape, or target body condition, such as current body type and ideal body type.

The term “emotion information” refers to data representing a psychological or emotional state of the user, including at least one of stress, joy, sadness, calmness, or other affective state, and may be derived from explicit user input or from sensor data such as images or audio.

The term “merchandise information” refers to data stored in the storage device that describes items available for recommendation, including at least one of identification information, price information, size information, style information, color information, and attribute information related to body suitability.

The term “health information” refers to data stored in the storage device that describes elements of health management, including at least one of food items, nutritional values, diet patterns, exercise types, exercise intensities, and templates for health management plans.

The term “candidate information” refers to a subset of at least one of the merchandise information and the health information, retrieved from the storage device based on the input information and used as constrained options for subsequent processing by a generative AI model.

The term “candidate merchandise information” refers to merchandise-related candidate information, retrieved from the storage device using conditions such as price information, style information, and attribute information associated with body information, and used as a limited set of items from which a generative AI model selects recommended merchandise.

The term “attribute information” refers to data associated with merchandise information or health information that describes characteristics relevant to matching with the user, including at least one of style tags, silhouette tags, body-type suitability tags, color properties, nutritional properties, or exercise characteristics.

The term “prompt sentence” refers to a text data structure formatted as natural language or machine-readable text, generated by the processor based on input information and candidate information, and supplied as input to a generative AI model to instruct generation of proposal information.

The term “generative AI model” refers to a machine-implemented model based on machine learning, such as a neural network model, that receives a prompt sentence and produces generated content including at least merchandise proposal information and health management plan information.

The term “merchandise proposal information” refers to generated information that recommends one or more merchandise items, including at least identification information, and may further include explanation information, ranking information, or suitability information corresponding to user attributes.

The term “health management plan information” refers to generated information that describes a plan for health management, including at least day-by-day or period-based information on one or more of diet, nutrition, and exercise, and that is adapted to the body information and emotion information of the user.

The term “merchandise identification information” refers to data that uniquely or specifically identifies a merchandise item within the storage device, such as a code, identifier, or name, and that enables retrieval of corresponding merchandise information.

The term “emotion identification model” refers to a computational model, implemented by software executed on the processor, configured to process sensor data such as image information or audio information to determine an emotion state of the user.

The term “emotion state” refers to a classification result output by the emotion identification model or derived from emotion information, indicating a particular emotional condition of the user, such as stress, joy, sadness, or calmness, used for controlling generation of proposal information.

The term “merchandise proposal formatting” refers to processing by the processor that associates merchandise proposal information generated by the generative AI model with corresponding merchandise information retrieved from the storage device and structures the associated information into a format suitable for output to the terminal.

The term “day-by-day information” refers to health management plan information structured on a per-day basis, including, for each day, at least one of diet content, nutritional targets, or exercise content.

The term “reuse” refers to processing by which stored prompt sentences and stored outputs of the generative AI model are accessed in subsequent processing to influence at least one of generation of another prompt sentence, selection of candidate information, or adjustment of proposal information, without recomputing all information from scratch.

The term “output information” refers to information sent from the system to the terminal, including at least the merchandise proposal information and the health management plan information formatted for presentation to the user.

In one embodiment, a server cooperates with a terminal operated by a user to provide merchandise proposal information and health management plan information based on structured input information and constrained candidate information, using a generative AI model controlled by a specially constructed prompt sentence.

A server comprises at least one processor, at least one memory, and at least one storage device. The storage device stores executable programs, merchandise information, health information, candidate information, prompt sentences, outputs of a generative AI model, and model parameters. The processor executes programs stored in the memory to implement the functions described below.

A terminal comprises a processor, a memory, a communication interface, at least one input interface, and at least one display. The terminal may be a smartphone, a tablet, a head-mounted display, or another portable electronic apparatus. The terminal executes an application (for example, implemented using an application framework corresponding to a mobile operating system) that presents user interface elements and communicates with the server over a wired or wireless network using a communication protocol such as HTTPS.

A user operates the terminal to provide input information. The user inputs budget information, preference information, body information, and emotion information through user interface elements such as text fields, selection lists, sliders, and buttons. The user may additionally provide sensor data, such as facial images captured by a camera or voice signals captured by a microphone of the terminal, as part of the emotion information. The terminal converts the user input into structured data and transmits the structured data to the server via the communication interface.

The server uses specific software components to implement the invention. In one embodiment, the server uses a general-purpose operating system, a web application framework such as a representative server-side framework implemented in a high-level programming language (for example, a Python-based framework), and a relational database management system such as a lightweight file-based database engine for smaller scale or a networked relational database system for larger scale. The server uses a machine learning framework such as a tensor computation framework or a deep learning framework to implement a generative AI model and an emotion identification model.

The server stores merchandise information and health information in relational database tables. Merchandise information is stored in a merchandise table that contains, as columns, merchandise identification information (such as an item identifier), category information, price information, size information, style information, color information, and attribute information including body-type suitability tags and silhouette tags. Health information is stored in a health table that contains, as columns, food identifiers, meal templates, nutritional values (such as calories and macro-nutrient values), exercise identifiers, exercise types, and recommended intensities and durations.

The server stores prompt sentences and outputs of the generative AI model in separate tables or collections. A prompt sentence table stores, for each prompt sentence, an identifier, a textual prompt, associated user attributes, and a timestamp. An output table stores, for each model output, an identifier, a reference to the corresponding prompt identifier, generated merchandise proposal information, and generated health management plan information.

The server executes an emotion identification model when the user provides image information or audio information as part of the emotion information. In one embodiment, the emotion identification model is a convolutional neural network configured to process facial image data. The network includes convolutional layers, pooling layers, and fully connected layers that output probabilities over discrete emotion classes such as “joy,” “stress,” “sadness,” and “calm.” In another embodiment, the emotion identification model is a recurrent or transformer-based network configured to process audio features extracted from voice signals. In each case, the server performs feature extraction, such as image normalization, cropping, and resizing for images, or spectrogram computation for audio, and feeds the extracted features to the emotion identification model. The server then selects the emotion state corresponding to the highest probability as the emotion state of the user.

The server implements the generative AI model as a neural network architecture such as a transformer-based sequence model. The generative AI model uses a multi-layer self-attention architecture with positional encodings and feed-forward layers. The model receives a prompt sentence as a sequence of tokens and generates a sequence of output tokens representing merchandise proposal information and health management plan information. The server configures the model with a vocabulary, embedding dimension, number of attention heads, number of layers, and other hyperparameters selected to balance response quality and computational efficiency.

The server trains or fine-tunes the generative AI model on training data that include pairs of prompt sentences and desired outputs. The training procedure uses supervised learning with a loss function such as cross-entropy loss over predicted tokens. The server updates the model parameters using an optimization algorithm such as stochastic gradient descent or an adaptive gradient method. During training, the server may perform data augmentation on prompt sentences or use curriculum strategies to expose the model to various structures of candidate information. By training the model to attend explicitly to embedded candidate merchandise information and health information, the server causes the model to learn non-conventional patterns of selection and planning that differ from human ad-hoc rule-based reasoning, thereby achieving high consistency with stored data and improved computational behavior.

The server uses structured data processing algorithms to construct candidate information. The server receives the structured input information from the terminal and performs database queries to extract candidate merchandise information. For example, the server applies a filter on the merchandise table using conditions such as price less than or equal to the budget, style tags matching the preference information, and attribute tags matching the body information. The server may use an index on price and style attributes to accelerate query processing. The server then retrieves a limited number of candidate merchandise records, such as the top N items sorted by relevance or popularity, and converts them into an internal data structure that includes identifier, price, size, style tags, color tags, and body-type suitability tags.

The server generates candidate health information by retrieving, from the health table, meal templates and exercise templates that correspond to the target body condition implied by the body information and the emotion information. For example, the server retrieves light-intensity exercise records and meals with balanced nutrition for a user whose emotion state is “stress,” and retrieves higher-intensity exercise templates for a user whose emotion state is “calm” and whose body information indicates a target of weight reduction.

The server constructs a prompt sentence by combining input information and candidate information into a predefined textual format. The server uses a prompt generation module executed on the processor to convert structured candidate merchandise information and structured health information into ordered textual segments. The prompt generation module uses explicit markers and ordering rules so that the generative AI model can recognize boundaries of lists and attributes. The server further embeds user-specific input information, including budget information, preference information, body information, and the identified emotion state, into descriptive text preceding the candidate lists.

For example, the server may generate a prompt sentence as follows:

“The user's budget is 10,000 yen. The user prefers casual style. The current body type is broad shoulders, and the ideal body type is a slimmer waist. The user is feeling stressed.

### Candidate Clothing Items

ID 101: Casual Slim Shirt A, price 4,500 yen, size L, style casual, tags: slim fit, dark color.
ID 102: Casual Jacket B, price 6,000 yen, size M, style casual, tags: structured shoulders, bright color.
ID 103: Straight Pants C, price 4,800 yen, size 32, style casual, tags: straight fit, dark color.

Based on the user's conditions and the above candidate items, select and describe the best 3 items that stay within the budget, visually slim the waist, and are comfortable for a stressed user. Also, generate a 7-day stress-relief diet and light exercise plan that helps the user move from the current body type toward the ideal body type.”

In another example, the server may generate a prompt sentence focusing on fashion recommendations only:

“The user's budget is 5,000 yen. The user prefers casual clothing. The current body type is broad shoulders, and the ideal body type is a slimmer waist. The user's emotional state is neutral.

### Candidate Clothing Items

ID 201: Casual Slim Shirt Navy, price 4,500 yen, size L, style casual, tags: slim fit, dark color, vertical stripes.
ID 202: Relaxed T-Shirt White, price 3,000 yen, size L, style casual, tags: loose fit, light color.
ID 203: Straight Jeans Black, price 4,800 yen, size 32, style casual, tags: straight fit, dark color.

Based on the user's body type and ideal body type, choose up to 3 items that stay within the 5,000 yen budget and visually emphasize a slimmer waist while fitting broad shoulders. For each selected item, output the ID and a short explanation describing why it is suitable.”

The server, by embedding candidate information as explicit lists with identifiers and attributes, constrains the generative AI model to select from actual stored items rather than generating arbitrary item descriptions. This structure modifies the operation of the generative AI model, causing the attention mechanism within the transformer architecture to focus on token subsequences corresponding to candidate entries. As a result, the generative AI model produces outputs that are inherently linked to the candidate items, thereby reducing hallucinated outputs and avoiding mismatches with the underlying database. This leads to fewer correction steps, less repeated querying, and reduced network and storage traffic, thereby improving computational efficiency and response time.

The server formats merchandise proposal information by post-processing the output of the generative AI model. The server parses the output text to identify merchandise identification information referenced by the generative AI model, such as “ID 101” or “ID 201.” The server then performs database lookups using these identifiers to fetch full merchandise information from the merchandise table. The server associates each recommended identifier with corresponding price, size, style, color, and attribute information, and adds generated explanation text for that item. The server then creates a structured response object for transmission to the terminal.

The server formats health management plan information by splitting the generated text into day-by-day entries. The server may also map referenced food items and exercises to records in the health table to verify availability and to compute nutritional values or exercise load. By aligning generated entries with structured health data, the server maintains consistency and supports additional computations such as calorie totals.

The server stores each prompt sentence and corresponding model output in the storage device. The server uses this stored data to adapt future processing. For example, when similar input information appears, the server may compare new input with stored prompt and output pairs using a similarity metric and then reuse or adjust a previous prompt sentence instead of constructing a new one from scratch. This reuse reduces the number of database queries and model inference operations, directly improving processing speed and resource utilization.

The server improves computer technology in multiple ways. By structuring candidate data and embedding it in the prompt sentence, the server alters internal attention patterns of the generative AI model, leading to more focused and efficient token generation. This reduces the number of tokens needed to reach a valid solution, lowers computation time on the processor or accelerator, and decreases energy consumption. By constraining outputs to candidate information, the server reduces post-processing complexity and data cleaning operations, lowering memory usage and storage access. By integrating emotion identification tightly into the prompt generation pathway, the server avoids multiple redundant model calls and simplifies the overall pipeline, resulting in lower end-to-end latency and improved throughput.

The server uses learning procedures and model structures that are not simple automation of human decision making. The server uses learned embedding spaces, attention distributions, and error-driven weight updates to identify complex interactions between budget information, preference information, body information, emotion information, and candidate attributes. Such multi-dimensional, high-dimensional vector computation is not practically achievable with manual human rules and results in improved matching precision and stability. The server also uses non-standard rules for prompt generation and candidate embedding, including explicit attribute ordering, consistent identifier labeling, and redundancy control, so that the generative AI model can optimize internal computation over a constrained domain.

The terminal displays the merchandise proposal information and the health management plan information to the user. The terminal may display items using cards with images, names, prices, sizes, and explanation text, and may present health plans using calendar or list representations grouped by day. The terminal can also adapt its display based on emotion information, such as using different color schemes or highlight styles. From the perspective of the overall system, the coordinated server-terminal operation leads to reduced communication overhead because the server transmits compact structured results rather than large sets of raw candidate data.

Alternative embodiments are possible. The server may use different model architectures, such as an encoder-decoder transformer, a recurrent neural network, or a hybrid system that uses a classical ranking model followed by a generative model. The server may use different optimization algorithms, different loss functions, or additional regularization techniques during training. The storage device may use non-relational databases or a combination of relational and non-relational storage. The terminal may be a desktop computer, a kiosk in a physical store, or a wearable device. The emotion identification model may use multi-modal data combining image features and audio features with sensor readings such as heart rate. The system may focus only on merchandise proposal information, only on health management plan information, or on other types of proposal information, as long as the processor uses structured candidate information and prompt sentence generation to control a generative AI model.

Through these embodiments, the server, the terminal, and the user cooperate to implement a technical scheme in which the generative AI model is not used as a generic text generator, but is integrated into a constrained, data-consistent architecture that improves accuracy, speed, and resource efficiency of recommendation processing within the computer system.

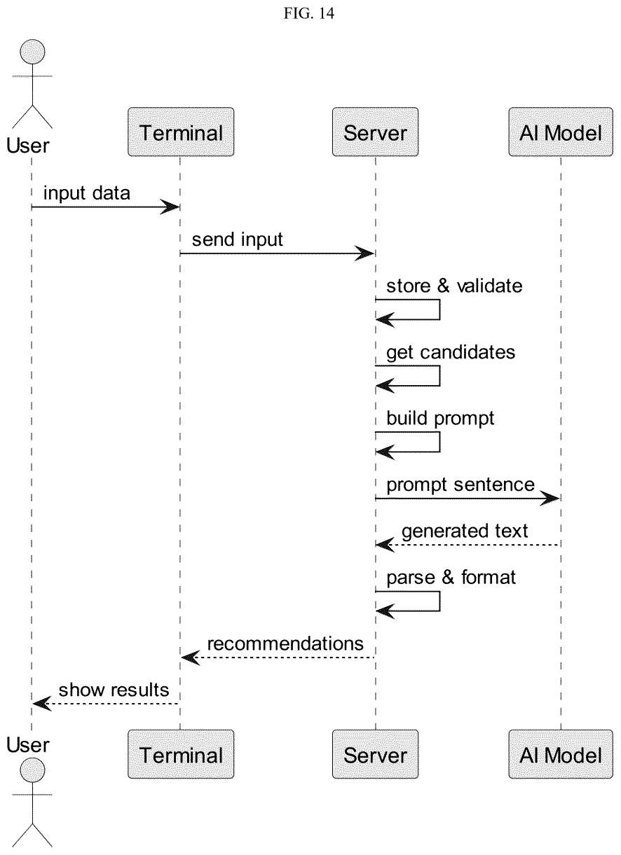

The following describes the processing flow using FIG. 14.

### Step 1

User operates the terminal to provide input information.

User launches an application on the terminal and inputs budget information, preference information, body information, and emotion information using graphical user interface elements such as text fields, selection boxes, and sliders. As input, the terminal receives raw interaction data from the user (keystrokes, touch events, selected options) and optionally image data from a camera or audio data from a microphone. As output, the terminal generates a structured input object containing normalized values for budget, preference tags, body-type descriptors, and either explicit emotion labels or raw sensor data for emotion estimation.

### Step 2

Terminal transmits structured input information to the server.

Terminal takes the structured input object as input and serializes it into a message format such as JSON. Terminal then performs data validation (for example, checking that budget is numeric and mandatory fields are not empty) and attaches metadata such as a user identifier and timestamp. Terminal uses a communication interface to send the serialized message via a secure protocol to a predefined application programming interface endpoint on the server. As output, the terminal produces a network request containing the structured input information and enters a state waiting for a response from the server.

### Step 3

Server receives and stores the input information.

Server receives the network request as input through a network interface and decodes the serialized message into internal data structures. Server performs schema validation and type checking on the fields. Based on this input, server executes database insertion operations to store the input information in a request log table, including fields such as user identifier, budget, preference, body attributes, emotion data, and timestamp. As output, the server produces validated and persisted input records that can be referenced by later processing stages.

### Step 4

Server derives or refines emotion information.

Server takes as input either an explicit emotion label from the structured input information or sensor data such as images or audio. If sensor data is present, server applies preprocessing operations: for images, server performs resizing, cropping, and normalization; for audio, server computes time-frequency representations such as spectrograms or mel-frequency cepstral coefficients. Server inputs the preprocessed features into an emotion identification model implemented as a neural network and computes an emotion probability distribution. Based on this distribution, server selects a dominant emotion state such as joy, stress, or sadness. As output, server generates a normalized emotion label and an associated confidence value, which are added to the internal representation of the user's state.

### Step 5

Server retrieves candidate merchandise information.

Server takes the validated input information and the normalized emotion label as input. Server issues structured database queries against merchandise tables using the budget, preference, and body attributes as filter conditions. For example, server filters rows where price is less than or equal to the budget, style attributes match the preference, and body-type suitability tags correspond to body information such as broad shoulders or slim waist. Server may also use indices and sort operations to rank candidates by relevance or popularity. As output, server produces a list of candidate merchandise records, each including identification information, price, size, style tags, color tags, and body-type suitability tags.

### Step 6

Server retrieves candidate health information.

Server uses body information and emotion information as input and performs queries against health tables containing meals and exercises. Server applies conditions on target body state, such as weight reduction or muscle gain, and emotion-related constraints, such as lower intensity exercise plans for stress states. Server filters entries based on nutritional values and exercise intensity ranges and may group them into templates for daily plans. As output, server generates a set of candidate health records, including meal identifiers, exercise identifiers, nutritional parameters, and recommended frequencies or durations.

### Step 7

Server constructs a structured prompt sentence.

Server takes as input the structured user information, the list of candidate merchandise records, and the set of candidate health records. Server executes a prompt generation module that converts these structured data elements into a prompt sentence in natural language. The module performs data concatenation, attribute ordering, and insertion of explicit identifiers, creating text sections such as a description of user conditions and enumerated candidate lists. For example, server may generate a prompt sentence including lines like “The user's budget is 10,000 yen. The user prefers casual style. The current body type is broad shoulders, and the ideal body type is a slimmer waist. The user is feeling stressed. Candidate clothing items: ID 101: Casual Slim Shirt A, price 4,500 yen, size L, style casual, tags: slim fit, dark color.” As output, server produces a single text string that represents the prompt sentence configured to guide the generative AI model.

### Step 8

Server executes the generative AI model using the prompt sentence.

Server uses the prompt sentence as input and tokenizes the text into a sequence of tokens according to the vocabulary of the generative AI model. Server loads model parameters from the storage device into memory and performs forward computations layer by layer in a transformer-based architecture, including embedding lookup, positional encoding, self-attention operations, and feed-forward transformations. Server iteratively generates output tokens by selecting token probabilities at each decoding step according to a generation strategy such as sampling or greedy selection. As output, server obtains a sequence of tokens that it decodes into output text describing merchandise proposal information and health management plan information, including references to candidate item identifiers and structured day-by-day recommendations.

### Step 9

Server parses and validates the generated output.

Server takes the generated output text as input and uses parsing rules or pattern matching to extract merchandise identifiers, explanation segments, and plan segments. Server checks each extracted merchandise identifier against merchandise records in the database by performing lookup queries. If an identifier is invalid or missing, server discards or replaces that recommendation based on remaining valid candidates. Server splits the health plan text into days and, where possible, maps referenced food or exercise names back to stored health records. As output, server produces cleaned and normalized merchandise proposal structures and a structured health management plan, each suitable for direct use or display.

### Step 10

Server formats response data for transmission to the terminal.

Server takes the normalized proposal structures and health plan as input and composes a response object with a defined schema. Server combines each recommended merchandise identifier with full attribute information from the database and attaches the generated explanation for that item. Server organizes the health management plan into an ordered series of days, each containing one or more meals and exercises. Server then serializes this structured data into a message format and adds metadata such as processing time or recommendation identifiers. As output, server generates a serialized response that encapsulates merchandise proposal information and health management plan information ready for network transmission.

### Step 11

Server transmits the response to the terminal.

Server takes the serialized response as input and uses its communication interface to send the response over the network to the terminal that initiated the request. The server may apply compression or encryption as part of the transmission process. As output, the server produces a completed network response containing the recommendation data, and it updates internal logs or monitoring metrics to record that the response has been sent.

### Step 12

Terminal receives and renders the recommendation information.

Terminal receives the network response as input through its communication interface and deserializes the message into internal data structures. Terminal maps the merchandise proposal data to user interface components, such as lists or cards, that display item names, prices, sizes, style tags, and explanation text. Terminal maps the health plan data to timeline or list components showing daily meals and exercises. Based on this input, terminal renders the combined view on the display, optionally adjusting visual style depending on emotion-related properties. As output, terminal presents the merchandise proposal information and health management plan information to the user in a human-readable format.

### Step 13

User reviews the proposals and optionally selects items or plans.

User views the displayed merchandise items and health plan on the terminal and interacts with interface elements such as selection buttons and detail links. As input, user actions specify which items are of interest or whether the user accepts the suggested health plan. Terminal interprets these actions and updates its internal selection state or may generate a new request for revised recommendations. As output, user produces selection signals that the terminal can use either to initiate purchase processing or to cause a re-invocation of the server recommendation process with modified input information.

### Step 14

Terminal sends feedback or selection results to the server.

Terminal takes user selection state or feedback as input, such as selected merchandise identifiers, acceptance flags for the health plan, or dissatisfaction reasons. Terminal converts these into a structured message and sends it to the server using the communication interface. Terminal may also log local analytics data for later synchronization. As output, the terminal produces feedback data that the server can use to refine logging, update training datasets, or adjust future candidate retrieval and prompt generation strategies.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

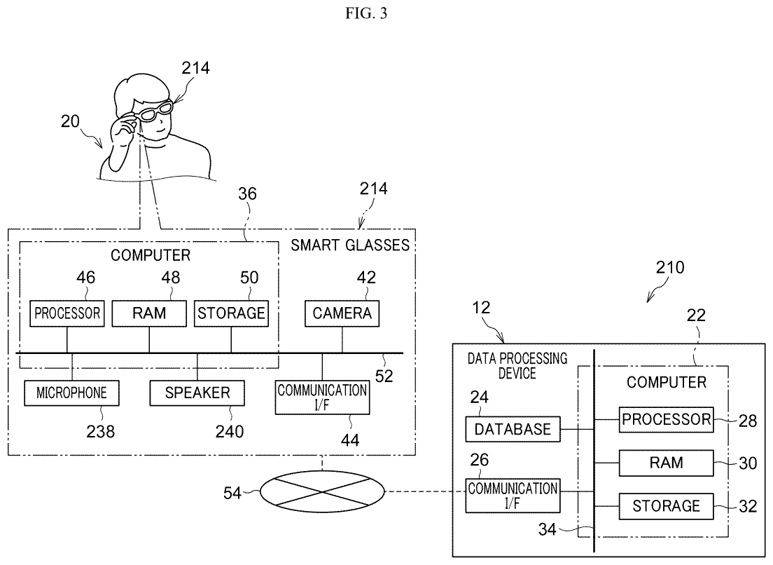

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

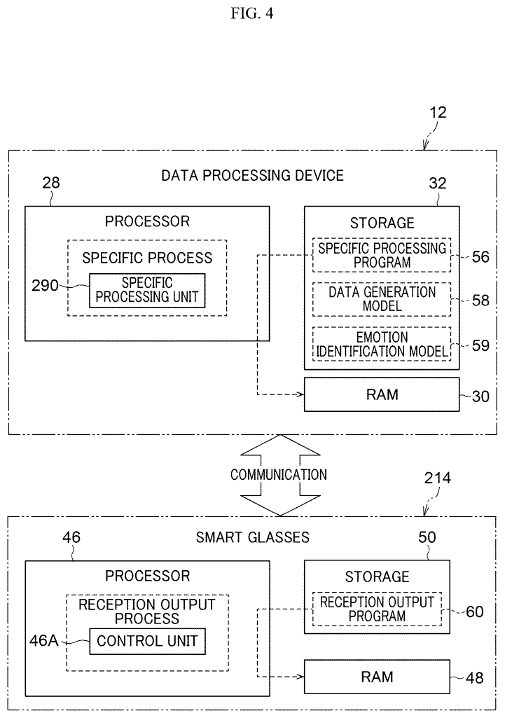

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

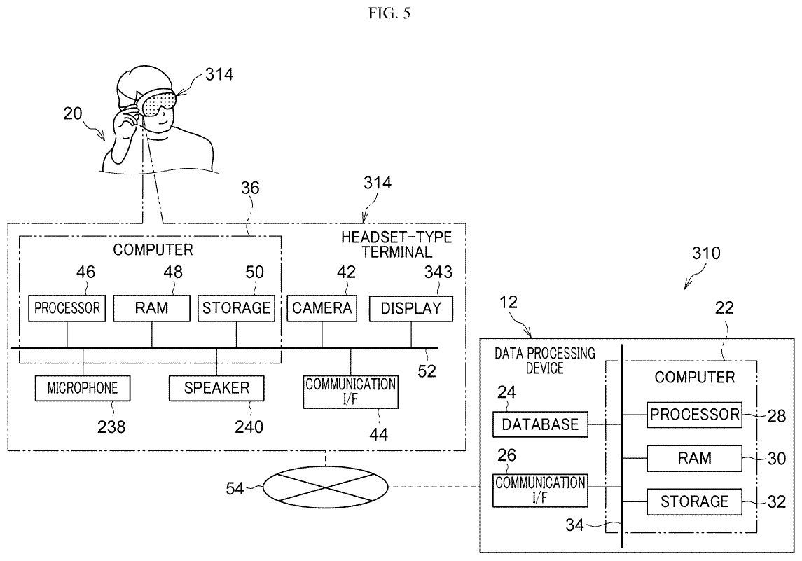

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

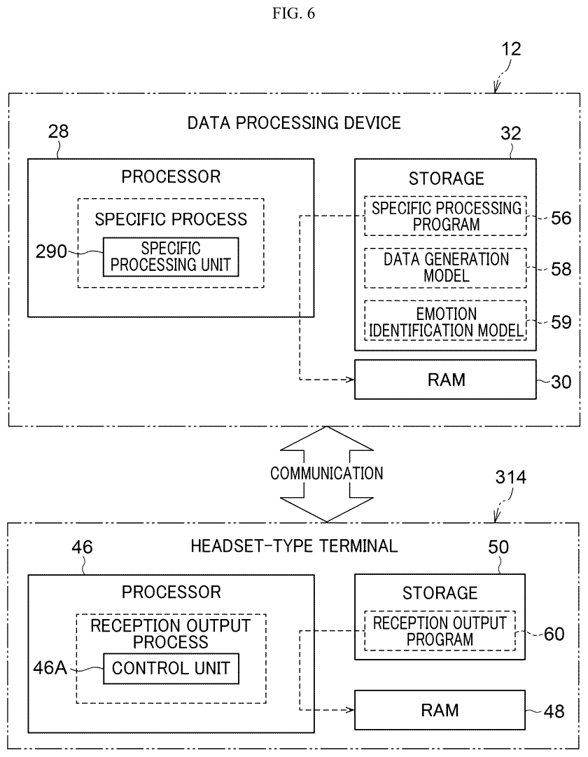

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

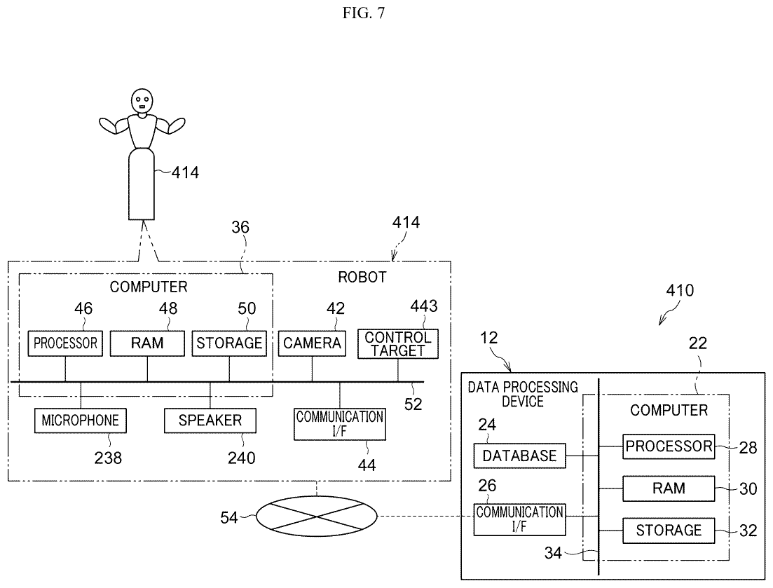

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

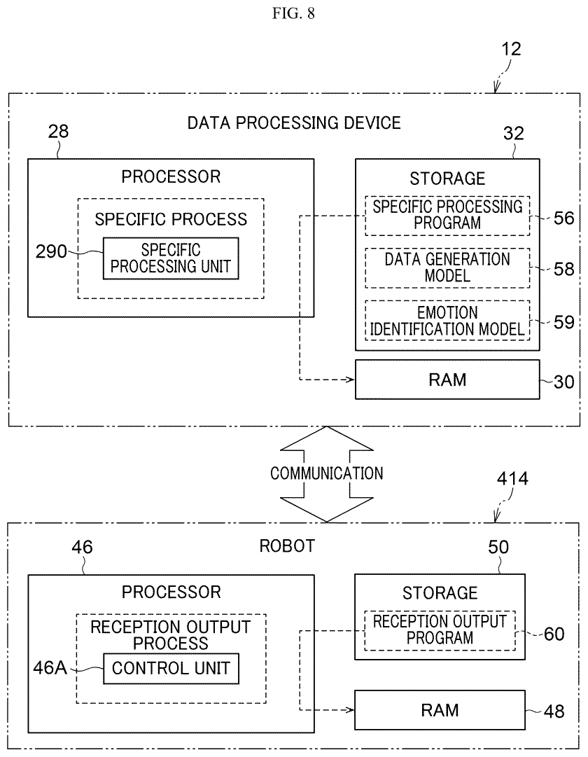

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

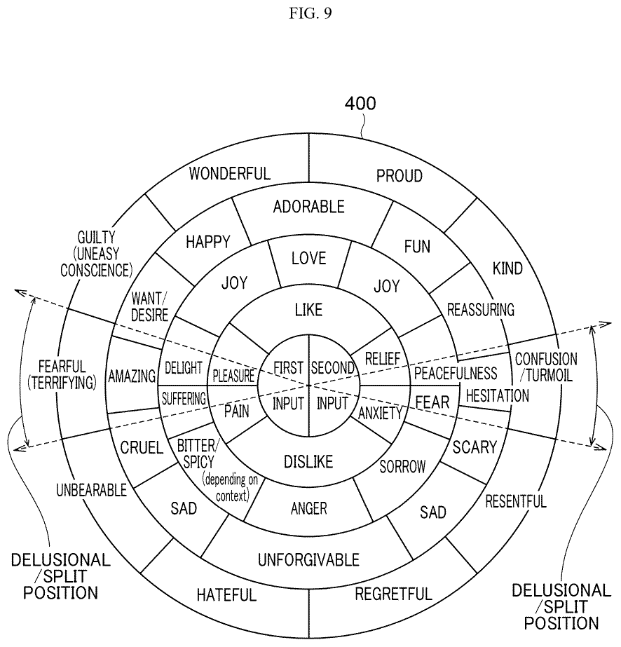

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

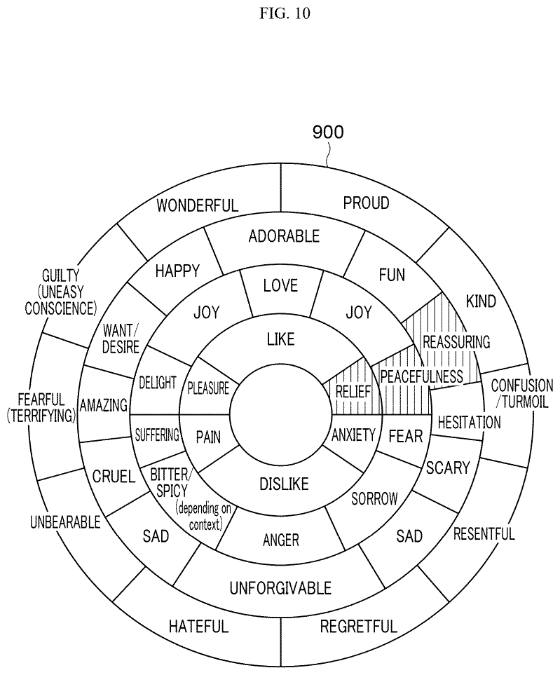

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from a terminal operated by a user, input information including budget information, preference information, current body information, and target body information, and store the input information as structured information in a storage device,
retrieve, based on the structured information, merchandise information that satisfies a price condition and a preference condition and nutrition information related to the current body information and the target body information from an information storage device, and generate document information by integrating the input information and retrieval results,
generate a first prompt sentence for input to a clothing-proposal generative AI model and a second prompt sentence for input to a meal-plan generative AI model, the first and the second prompt sentences including the document information,
input the first prompt sentence to the clothing-proposal generative AI model so as to cause the clothing-proposal generative AI model to generate clothing proposal information that satisfies the budget information and the preference information and corresponds to the current body information and the target body information,
input the second prompt sentence to the meal-plan generative AI model so as to cause the meal-plan generative AI model to generate meal plan information for bringing the current body information closer to the target body information,
generate response information by integrating the clothing proposal information and the meal plan information, and transmit the response information to the terminal, and
control display of the clothing proposal information and the meal plan information included in the response information on the terminal.

### Supplementary 2

The system according to supplementary 1,
wherein the processor is configured to
generate the first prompt sentence by including, in the first prompt sentence, attribute information of a plurality of clothing candidates obtained as the merchandise information together with the budget information and the preference information, the attribute information and the budget information and the preference information being described in a natural language, thereby causing the clothing-proposal generative AI model to generate the clothing proposal information that satisfies the price condition and the preference condition.

### Supplementary 3

The system according to supplementary 1,
wherein the processor is configured to
generate the second prompt sentence by including, in the second prompt sentence, nutrition requirement information calculated based on the current body information and the target body information and the nutrition information, the nutrition requirement information and the nutrition information being described in a natural language, thereby causing the meal-plan generative AI model to generate the meal plan information including meal information by day and by meal for a predetermined period.

### Application Example 1

### Supplementary 1

A system comprising a processor,
wherein the processor is configured to
acquire, in an information processing apparatus, input data including budget information, preference information, and body information of a user,
construct a prompt sentence to be input to a generative AI model based on the acquired input data,
input the constructed prompt sentence to the generative AI model to cause the generative AI model to generate response data including apparel information that satisfies budget conditions and preference conditions and nutrition intake plan information corresponding to a body target condition,
compare the apparel information included in the generated response data with merchandise information stored in a merchandise information storage unit, extract apparel candidates based on price conditions and size conditions, and rank the apparel candidates based on an evaluation value,
calculate shape parameters of a three-dimensional human body model based on the body information of the user, and input the shape parameters and three-dimensional apparel models corresponding to the apparel candidates to a three-dimensional image generation program to generate virtual try-on images,
perform numerical computation processing and rule processing on the generated nutrition intake plan information to structure the nutrition intake plan information as a meal plan on a daily basis or a period basis, and
output the apparel candidates, the virtual try-on images, and the meal plan to a terminal device.

### Supplementary 2

The system according to supplementary 1,
wherein the processor is configured to
update the prompt sentence to optimize apparel recommendation in the generative AI model by including, in the prompt sentence to be input to the generative AI model, history information including preference information and rejection information of the user with respect to the apparel candidates in addition to the budget information and the preference information of the user.

### Supplementary 3

The system according to supplementary 1,
wherein the processor is configured to
reconstruct the meal plan by calculating energy expenditure from current body information and target body information of the user, selecting meal candidate information output from the generative AI model based on predetermined nutrient distribution rules and intake restriction conditions, and arranging the selected meal candidate information as a meal plan on a daily basis or a period basis.

### Example 2

### Supplementary 1

A system comprising a processor,
wherein the processor is configured to
receive, from a terminal, user attribute information and preference information, and structure the information as input information including budget information, product preference information, body information, and body target information,
obtain, based on the input information, candidate product information that satisfies a budget condition and a product preference condition from a product information storage apparatus, and obtain body rule information associated with the body information and the body target information from a body information storage apparatus,
generate a prompt sentence including the input information, the candidate product information, and the body rule information, input the prompt sentence to a generative information processing model, and cause the generative information processing model to generate product proposal information and health management plan information to be provided to a user, and
transmit the generated product proposal information and the health management plan information to the terminal as response information formatted in a displayable form on the terminal.

### Supplementary 2

The system according to supplementary 1,
wherein the processor is configured to, in obtaining the candidate product information, select, from among a plurality of pieces of product information obtained from the product information storage apparatus, only product information that satisfies the budget information and the product preference information based on a price attribute and a style attribute, and include the selected product information in the prompt sentence.

### Supplementary 3

The system according to supplementary 1,
wherein the processor is configured to, in generating the health management plan information, include, in the prompt sentence, weight difference information and period condition information based on the body information and the body target information, and instruct the generative information processing model to generate the health management plan information including diet guideline information and exercise guideline information.

### Application Example 2

### Supplementary 1

A system comprising a processor and a storage device,
wherein the processor is configured to
acquire, from a terminal of a user, input information including budget information, preference information, body information, and emotion information of the user,
obtain, from the storage device storing merchandise information and health information, candidate information based on the input information,
generate a prompt sentence for input to a generative AI model based on the input information and the candidate information,
input the prompt sentence to the generative AI model and generate merchandise proposal information and health management plan information based on an output of the generative AI model,
output the merchandise proposal information and the health management plan information to the terminal of the user,
acquire, from the storage device, merchandise information corresponding to merchandise identification information included in the output of the generative AI model, and format the merchandise proposal information in association with the acquired merchandise information, and
store the prompt sentence and the output of the generative AI model in the storage device and use the stored prompt sentence and output in at least one of generation of another prompt sentence and acquisition of other candidate information in subsequent generation processing.

### Supplementary 2

The system according to supplementary 1,
wherein the processor is configured to
acquire, as at least part of the emotion information, image information or audio information of the user, execute an emotion identification model using the image information or the audio information to identify an emotion state of the user, provide a result of the identification to a unit that generates the prompt sentence, generate the prompt sentence including information indicating the emotion state, and cause the generative AI model to generate the merchandise proposal information and the health management plan information in consideration of at least one condition relating to color tone, silhouette, or comfort corresponding to the emotion state.

### Supplementary 3

The system according to supplementary 1,
wherein the processor is configured to
perform a search process on the merchandise information stored in the storage device using price information, style information, and attribute information associated with the body information to obtain candidate merchandise information, embed the candidate merchandise information as a list including identification information and attribute information in the prompt sentence, cause the generative AI model to select, from among the candidate merchandise information, merchandise that matches the budget information, the preference information, the body information, and the emotion information of the user, and cause the generative AI model to generate, based on the body information and the emotion information, the health management plan information including day-by-day information relating to at least one of diet and exercise.

What is claimed is:

1. A system comprising:
circuitry configured to:
acquire, via a communication interface coupled to a packet-switched network, user attribute data and preference attribute data encoded as packet data from a terminal device, normalize the acquired data into a standardized data format including a numeric constraint parameter, a classification label parameter, a current condition parameter set, and a target condition parameter set, and store the normalized data as multidimensional feature tensors in a storage device;
retrieve, by executing indexed query operations on the storage device using cosine similarity between vector representations of the classification label parameter and stored attribute vectors, candidate data records satisfying a constraint derived from the numeric constraint parameter and the classification label parameter, and retrieve reference parameter records associated with the current condition parameter set and the target condition parameter set from an information storage region of the storage device;
generate integrated context data by combining the normalized data, the candidate data records, and the reference parameter records into a structured data representation, and construct a first instruction sequence and a second instruction sequence from the integrated context data by tokenization and positional encoding, each instruction sequence embedding constraint parameters and retrieved record attributes as structured token subsequences;
input the first instruction sequence into a first generative neural network model comprising a transformer-based architecture with multi-layer self-attention sublayers and feed-forward sublayers to cause the first generative neural network model to generate first inference output data constrained by the numeric constraint parameter and the classification label parameter, and input the second instruction sequence into a second generative neural network model comprising a transformer-based architecture to cause the second generative neural network model to generate second inference output data corresponding to a transition from the current condition parameter set toward the target condition parameter set;
parse output token sequences obtained from the first generative neural network model and the second generative neural network model to convert the output token sequences into structured data records by detecting delimiter tokens and extracting field values, and generate composite output data by integrating the structured data records derived from the first inference output data and the second inference output data; and
transmit the composite output data to the terminal device via the communication interface for rendering on a display of the terminal device.

2. The system according to claim 1, wherein the circuitry is further configured to:
derive the numeric constraint parameter as a numeric upper-bound value from a monetary amount field of the user attribute data, derive the classification label parameter by mapping a textual input value to a canonical category label using a synonym normalization table stored in the storage device, and derive the current condition parameter set and the target condition parameter set each as a set of dimensional attribute values including at least a size attribute value and a shape attribute value.

3. The system according to claim 2, wherein the circuitry is further configured to:
execute the indexed query operations by applying a range filter on a price attribute of the candidate data records using the numeric upper-bound value and applying an equality filter on a category attribute of the candidate data records using the canonical category label, and compute a relevance score for each retrieved candidate data record based on a weighted combination of attribute match values.

4. The system according to claim 3, wherein the circuitry is further configured to:
compute a condition-differential vector representing differences between the current condition parameter set and the target condition parameter set, and retrieve the reference parameter records by matching the condition-differential vector to entries in a rule data table stored in the information storage region, each entry associating a condition-differential range with recommended attribute parameters and transition guideline data.

5. The system according to claim 4, wherein the circuitry is further configured to:
construct the first instruction sequence by inserting, into a template data structure stored in the storage device, the numeric constraint parameter, the classification label parameter, and attribute fields of each candidate data record at designated placeholder positions, and construct the second instruction sequence by inserting the current condition parameter set, the target condition parameter set, the condition-differential vector, and the reference parameter records into a separate template data structure, each template data structure including a directive segment specifying output format constraints.

6. The system according to claim 1, wherein the first generative neural network model and the second generative neural network model each comprise:
an embedding layer configured to map input tokens to dense vector representations, a positional encoding layer, a plurality of transformer blocks each including a multi-head self-attention sublayer and a feed-forward sublayer with layer normalization, and an output layer configured to generate probability distributions over a token vocabulary, and
wherein the circuitry is configured to apply a decoding strategy including at least one of beam search decoding, top-k sampling, or temperature-controlled sampling to generate the output token sequences.

7. The system according to claim 6, wherein the circuitry is further configured to:
parse the output token sequences by detecting structured delimiter markers in the generated text, extracting field values corresponding to record identifiers, attribute descriptors, and explanatory text segments from the first inference output data, and extracting schedule entries, quantity values, and guideline text segments from the second inference output data, and validate each extracted record identifier against records stored in the storage device.

8. The system according to claim 7, wherein the circuitry is further configured to:
execute the first generative neural network model and the second generative neural network model on separate hardware accelerators, schedule inference operations for the first instruction sequence and the second instruction sequence as asynchronous parallel tasks, and merge output token sequences from both models into the composite output data upon completion of both tasks.

9. The system according to claim 1, wherein the circuitry is further configured to:
compute, for each candidate data record retrieved from the storage device, a similarity score between a vector representation of a generated description in the first inference output data and a vector representation of attribute data of the candidate data record using a similarity metric, and select, based on the similarity scores, one or more matched candidate data records corresponding to each generated description.

10. The system according to claim 9, wherein the circuitry is further configured to:
apply multi-constraint filtering to the matched candidate data records by verifying that a total value of a combination of matched candidate data records does not exceed the numeric constraint parameter and that a dimensional compatibility value of each matched candidate data record satisfies the current condition parameter set, and discard combinations that violate the numeric constraint parameter or the dimensional compatibility value.

11. The system according to claim 10, wherein the circuitry is further configured to:
compute an evaluation value for each remaining candidate data record or combination thereof by aggregating a classification similarity feature, a relevance score feature, an availability feature, and a normalized value feature using a weighted scoring function, and arrange the candidate data records in a descending order of the evaluation value for inclusion in the composite output data.

12. The system according to claim 1, wherein the circuitry is further configured to:
calculate shape parameters of a three-dimensional model by mapping dimensional attribute values of the current condition parameter set to morph coefficients and skeletal scaling factors using transformation functions stored in the storage device, and apply the shape parameters to a base three-dimensional mesh model stored in a model repository to generate a deformed three-dimensional model approximating the user.

13. The system according to claim 12, wherein the circuitry is further configured to:
input the shape parameters and three-dimensional object models corresponding to matched candidate data records to a three-dimensional rendering engine, configure camera viewpoint parameters, lighting parameters, and background parameters, and execute the three-dimensional rendering engine to generate visualization image data representing the deformed three-dimensional model combined with the three-dimensional object models, and include the visualization image data in the composite output data.

14. The system according to claim 1, wherein the circuitry is further configured to:
perform numerical computation on the second inference output data by calculating a target daily intake value and a distribution parameter set based on the current condition parameter set and the target condition parameter set using stored physiological formulas, compare entries in the second inference output data against the target daily intake value and the distribution parameter set, adjust quantity values to satisfy the distribution parameter set within a predetermined tolerance, and organize the adjusted entries into a schedule structured on a per-period basis.

15. The system according to claim 14, wherein the circuitry is further configured to:
store, in the storage device, history data indicating acceptance records and rejection records associated with previously transmitted composite output data, and construct an updated first instruction sequence or an updated second instruction sequence that includes history-derived preference adjustment data and history-derived exclusion data extracted from the history data, for input to the first generative neural network model or the second generative neural network model in subsequent processing.

16. The system according to claim 1, wherein the circuitry is further configured to:
acquire sensor data including at least one of image data captured by a camera of the terminal device or audio data captured by a microphone of the terminal device, input the sensor data into an emotion identification model comprising a neural network configured to output probability values over a plurality of emotion categories, determine an emotion state of the user based on the probability values, and adjust at least one constraint parameter embedded in the first instruction sequence or the second instruction sequence based on the determined emotion state.

17. The system according to claim 16, wherein:
the first inference output data comprises clothing recommendation information including one or more proposed clothing items or outfits constrained by a budget and a fashion style preference of the user and corresponding to a current body type and an ideal body type of the user,
the second inference output data comprises a meal plan including meal information organized by day and by meal for a predetermined period with calorie count information for transitioning from the current body type toward the ideal body type, and
the emotion state adjustment includes adjusting at least one of color tone preference, comfort level, or exercise intensity in the first inference output data or the second inference output data based on the emotion state of the user.

18. A system comprising:
circuitry configured to:
acquire, via a communication interface coupled to a packet-switched network, attribute data and constraint parameter data from a terminal device, and store the acquired data in a storage device;
retrieve, from the storage device, candidate records satisfying a constraint derived from the constraint parameter data by executing a query operation specifying at least a value-range condition and a classification-match condition;
generate an instruction sequence embedding candidate record identifiers and attribute data as structured token subsequences, and input the instruction sequence into a generative neural network model comprising a transformer-based architecture with a plurality of self-attention layers to cause the generative neural network model to generate inference output data including selected record identifiers and schedule data;
validate each selected record identifier in the inference output data against records stored in the storage device, and format validated inference output data and the schedule data as response data; and
store the instruction sequence and an output of the generative neural network model in the storage device for use in at least one of generation of a subsequent instruction sequence or retrieval of subsequent candidate records.

19. The system according to claim 18, wherein the circuitry is further configured to:
retrieve, from the storage device, a previously stored instruction sequence and a previously stored output associated with prior processing, compare attribute data of a current request with attribute data associated with the previously stored instruction sequence, and when a similarity between the current attribute data and the previously stored attribute data exceeds a predetermined threshold, modify the previously stored instruction sequence by updating differing constraint parameters to generate the subsequent instruction sequence, thereby reducing query operations and instruction sequence construction operations.

20. A method performed by circuitry, the method comprising:
acquiring, via a communication interface coupled to a packet-switched network, user attribute data and preference attribute data encoded as packet data from a terminal device, normalizing the acquired data into a standardized data format including a numeric constraint parameter, a classification label parameter, a current condition parameter set, and a target condition parameter set, and storing the normalized data as multidimensional feature tensors in a storage device;
retrieving, by executing indexed query operations on the storage device using cosine similarity between vector representations of the classification label parameter and stored attribute vectors, candidate data records satisfying a constraint derived from the numeric constraint parameter and the classification label parameter, and retrieving reference parameter records associated with the current condition parameter set and the target condition parameter set from an information storage region of the storage device;
generating integrated context data by combining the normalized data, the candidate data records, and the reference parameter records into a structured data representation, and constructing a first instruction sequence and a second instruction sequence from the integrated context data by tokenization and positional encoding, each instruction sequence embedding constraint parameters and retrieved record attributes as structured token subsequences;
inputting the first instruction sequence into a first generative neural network model comprising a transformer-based architecture with multi-layer self-attention sublayers and feed-forward sublayers to cause the first generative neural network model to generate first inference output data constrained by the numeric constraint parameter and the classification label parameter, and inputting the second instruction sequence into a second generative neural network model comprising a transformer-based architecture to cause the second generative neural network model to generate second inference output data corresponding to a transition from the current condition parameter set toward the target condition parameter set;
parsing output token sequences obtained from the first generative neural network model and the second generative neural network model to convert the output token sequences into structured data records by detecting delimiter tokens and extracting field values, and generating composite output data by integrating the structured data records derived from the first inference output data and the second inference output data; and
transmitting the composite output data to the terminal device via the communication interface for rendering on a display of the terminal device.
